(19) United States
(12) Patent Application Publication
(10) Pub. No.: US 2022/0131231 A1
(43) Pub. Date: Apr. 28, 2022

(54) A SOLID-STATE ELECTROLYTE MEMBRANE, A SECONDARY BATTERY COMPRISING A SOLID-STATE ELECTROLYTE MEMBRANE, AND A METHOD FOR MANUFACTURING A SOLID-STATE ELECTROLYTE MEMBRANE

(71) Applicant: Ampcera Inc., Milpitas, CA (US)

(72) Inventors: Hui Du, Tucson, AZ (US); James Emery Brown, Tucson, AZ (US); Chen Chen, Tucson, AZ (US); Sumin Zhu, San Franscisco, CA (US)

(21) Appl. No.: 15/734,378

(22) PCT Filed: Jun. 14, 2020
(86) PCT No.: PCT/US2020/037658

§ 371 Date: Dec. 2, 2020

Related U.S. Application Data
(60) Provisional application No. 62/861,234, filed on Jun. 13, 2019.
(60) Provisional application No. 62/943,423, filed on Dec. 4, 2019.

(51) Int. Cl. H01M 50/446; H01M 50/497; H01M 50/403; H01M 50/44

(52) U.S. Cl. CPC H01M 50/446; H01M 50/44; H01M 50/403; H01M 50/497

(57) ABSTRACT

A solid-state electrolyte membrane includes a fabric support and a ceramic-polymer composite solid-state electrolyte on the fabric support. A secondary battery includes a cathode, an anode, and a solid-state electrolyte membrane. The solid-state electrolyte membrane includes a fabric support and a ceramic-polymer composite solid-state electrolyte on the fabric support. A method for manufacturing a solid-state electrolyte membrane includes coating a ceramic-polymer composite solid-state electrolyte on a fabric support.

### PRIORITY

The present application claims the priority of U.S. Provisional Patent Application Nos. 62/861,234, filed Jun. 13, 2019, and 62/943,423, filed Dec. 4, 2019, both of which are incorporated herein by reference in their entireties.

### FIELD

The present disclosure relates to the field of solid-state electrolyte membranes, secondary batteries comprising solid-state electrolyte membranes, and methods for manufacturing solid-state electrolyte membranes. In an aspect, the present disclosure relates to a roll-to-roll processing method for the fabrication of freestanding-flexible solid-state electrolyte membranes in solid-state and semi-solid-state secondary batteries; wherein a ceramic-polymer composite solid-state electrolyte is coated on a fabric support in a roll-to-roll process to produce a freestanding membrane which may then be integrated into the production of said secondary batteries.

### BACKGROUND

Manufacturing freestanding-flexible solid-state electrolyte membranes using high-throughput roll-to-roll processing remains a critical challenge for the production of solid-state and semi-solid-state secondary batteries. Roll-to-roll processing approaches often require a delamination step to produce a freestanding membrane which reduces throughput and introduces unwanted defects. Accordingly, those skilled in the art continue with research and development in the field of solid-state electrolyte membranes, secondary batteries comprising solid-state electrolyte membranes, and methods for manufacturing solid-state electrolyte membranes.

### SUMMARY

In one embodiment, a solid-state electrolyte membrane includes a fabric support and a ceramic-polymer composite solid-state electrolyte on the fabric support. In another embodiment, a secondary battery includes a cathode, an anode, and a solid-state electrolyte membrane. The solid-state electrolyte membrane includes a fabric support and a ceramic-polymer composite solid-state electrolyte on the fabric support. In yet another embodiment, a method for manufacturing a solid-state electrolyte membrane includes coating a ceramic-polymer composite solid-state electrolyte on a fabric support. Other embodiments of the disclosed solid-state electrolyte membranes, secondary batteries comprising solid-state electrolyte membranes, and methods for manufacturing solid-state electrolyte membranes will become apparent from the following detailed description, the accompanying drawings and the appended claims.

### BRIEF DESCRIPTION OF THE DRAWINGS

FIG. 1 is a representation of a cross-section of a fabric support according to the present disclosure. FIG. 2 is a representation of a cross-section of the fabric support of FIG. 1 after coating with a slurry according to the present disclosure. FIG. 3 is a representation of a cross-section of the coated fabric support of FIG. 2 after drying to form a solid-state electrolyte membrane according to the present disclosure. FIG. 4 is a representation of a cross-section of the solid-state electrolyte membrane of FIG. 3 after densification (e.g. calendering) according to the present disclosure.

FIG. 5 a schematic illustration of a solid-state secondary metal battery incorporating a solid-state electrolyte membrane according to the present disclosure. FIG. 6 is schematic illustration of a semi-solid-state secondary metal battery incorporating a solid-state electrolyte membrane according to the present disclosure. FIG. 7 is a schematic illustration of a solid-state secondary battery incorporating a solid-state electrolyte membrane according to the present disclosure. FIG. 8 is a schematic illustration of a semi-solid-state secondary battery incorporating a solid-state electrolyte membrane according to the present disclosure.

FIG. 9 is a schematic illustration of an exemplary roll-to-roll process without a calendering system incorporated within. FIG. 10 is a schematic illustration of an exemplary roll-to-roll process with a calendering system incorporated into the process. FIG. 11 is a schematic illustration of a roll-to-roll process using gravure printing. FIG. 12 is a schematic illustration of a roll-to-roll process using a slurry casting. FIG. 13 is a schematic illustration of a roll-to-roll process using a slurry spray. FIG. 14 is a schematic illustration of a roll-to-roll process using screen printing.

### DETAILED DESCRIPTION

Manufacturing freestanding-flexible solid-state electrolyte membranes using high-throughput roll-to-roll processing remains a critical challenge for the production of solid-state and semi-solid-state secondary batteries. Roll-to-roll processing approaches often require a delamination step to produce a freestanding membrane which reduces throughput and introduces unwanted defects. To eliminate this step, a freestanding-flexible solid-state electrolyte membrane can be fabricated by coating a ceramic-polymer composite solid-state electrolyte slurry on a fabric support in a roll-to-roll process. The freestanding-flexible solid-state electrolyte membrane can then be integrated into existing pouch, cylindrical, or prismatic type fabrication processing, analogous to polypropylene separators, for solid-state or semi-solid-state secondary battery production.

The freestanding-flexible solid-state electrolyte membrane may be composed of a ceramic-polymer composite solid-state electrolyte coated on a fabric support. The fabric support may be composed of, for example, a textile-based fabric or a metal-mesh-based fabric. The ceramic-polymer composite solid-state electrolyte may be composed of a polymer, ionic conductive salt, and an ionic-conductive ceramic.

The freestanding-flexible solid-state electrolyte membrane may be formed by coating a ceramic-polymer composite solid-state electrolyte slurry on a stationary or continuously rolling fabric support in a roll-to-roll process. In such an approach, the fabric support is analogous to a substrate in a conventional roll-to-roll coating process. After coating, the freestanding-flexible solid-state electrolyte membrane may be dried to remove solvent. The freestanding-flexible solid-state electrolyte membrane may be calendered to densify the membrane, reduce porosity and thickness, enhance ionic conductivity, and prevent dendrite penetration.

The freestanding-flexible solid-state electrolyte membrane may be integrated into secondary batteries composed of a composite cathode, and a composite anode or metal/metal-alloy anode to form what is termed a solid-state secondary battery

The freestanding-flexible solid-state electrolyte membrane may be integrated into secondary batteries composed of a cathode or composite cathode, anode or composite anode or metal/metal-alloy anode, and a liquid-based electrolyte to form what is termed a semi-solid-state secondary battery.

The freestanding-flexible solid-state electrolyte membrane may be integrated into existing battery manufacturing to form pouch, cylindrical, or prismatic type solid-state or semi-solid-state secondary batteries.

The present disclosure relates to a roll-to-roll process for the fabrication of the freestanding-flexible solid-state electrolyte membrane. A freestanding-flexible solid-state electrolyte membrane may be fabricated by coating a ceramic-polymer composite solid-state electrolyte slurry on a fabric support in a roll-to-roll process.

In the coating process, the ceramic-polymer composite solid-state electrolyte may be coated into the porous network of the fabric support. In the coating process, the ceramic-polymer composite solid-state electrolyte may be coated onto surfaces of the fabric support. The terminology onto and into will be employed in the following description of the roll-to-roll process.

In an aspect, the ceramic-polymer composite solid-state electrolyte slurry is coated onto all surfaces of the porous network of the fabric support and the ceramic-polymer composite solid-state electrolyte slurry is coated into the porous network of the fabric support, resulting in a complete filling of the pores.

In an aspect, one side of the fabric support may be embedded within the ceramic-polymer composite solid-state electrolyte. In another aspect, the entire fabric support may be embedded within the ceramic-polymer composite solid-state electrolyte. By embedding one or both sides of the fabric support within a coating of ceramic-polymer composite solid-state electrolyte, exposed portions of the fabric support on either side of the membrane are avoided. Exposed portions may result in poor interfaces at the electrodes of the secondary battery. Therefore, the porous support is preferably completely embedded within the ceramic-polymer composite solid-state electrolyte so there is no exposed fabric support protruding from the surface.

In an aspect, the ceramic-polymer composite solid-state electrolyte is coated onto the fabric support as a single layer. Thus, one side of the fabric support may be embedded within a single layer of ceramic-polymer composite solid-state electrolyte, or the entire fabric support may be embedded within a single layer of ceramic-polymer composite solid-state electrolyte. By coating as a single layer, interfaces between layers of ceramic-polymer composite solid-state electrolyte can be avoided. Such interfaces may detrimentally result in higher cell impedance, or resistance, due to a reduction in ionic conductivity. In other words, it would be difficult to conduct ions across the interfaces.

The roll-to-roll processing equipment may be located in, but not limited to, a room at ambient conditions, a dry room, or in an inert atmosphere.

The roll-to-roll processing equipment may be located in a room at ambient conductions but constructed with environmental shielding to provide dry room like conditions or an inert atmosphere.

The roll-to-roll processing equipment may include existing commercial coating equipment such a slot-die coater for secondary battery electrodes. In this instance, it is expected that only minor adjustments to the printing head are applied to make the coating equipment compatible with the fabric support and the ceramic-polymer composite solid-state electrolyte slurry.

Alternatively, the roll-to-roll processing equipment may be a custom design for the fabric support and the ceramic-polymer composite solid-state electrolyte slurry.

The present disclosure relates to the roll-to-roll process. Components of the roll-to-roll process may include, but not limited to, an unwinding roller, tension rollers, guide rollers, coating equipment, drying oven, calender rollers, a winding roller, and a computer interface.

A spool of the fabric support may be attached and positioned onto the unwinding roller. The fabric support may be pulled through the roll-to-roll process and attached to the winding roller. The fabric support may be pulled through manually or using external automation such as a robotic arm. The length of the fabric support on the spool may range from 10≤L≤10000 meters, with a preferred range of 100≤L≤2000 meters.

The winding roller may be rotated to pull tension on to the fabric. It is assumed that the winding roller will be controlled through automation using a computer interface. An interface may be located on the processing equipment or external of the processing equipment. In the event of an external interface, a computer interface may control the automation wirelessly via Wi-Fi or though be wired connection. The number of initial rotations applied to provide sufficient tension may range from 1<r<50 rotations, with a preferred range of 3<r<10 rotations.

Sufficient tension on the fabric support is applied for uniform coating of the ceramic-polymer composite solid-state electrolyte slurry. A uniform coating of the freestanding-flexible solid-state electrolyte membrane is applied to ensure a uniform charge distribution in secondary batteries.

Tension rollers may be located throughout the roll-to-roll process to provide further tension to the fabric support. The tension rollers may be adjusted to optimize the tension on the fabric support. Tension rollers may be adjusted manually or through automation using a computer interface. In the case of automation, it is assumed that the roll-to-roll processing equipment is equipped with an automation feature for said tension rollers, in which case the adjustments may be controlled through a computer interface. An interface may be located on the processing equipment or external of the processing equipment. In the event of an external interface, the computer interface may control the automation wirelessly via Wi-Fi or though be wired connection. The number of tension rollers in the roll-to-roll process may range from 1≤N≤100, with a preferred range of 3≤N≤10.

Guide rollers are used to guide the fabric support in the roll-to-roll process. Guide rollers may also apply some additional tension to the fabric support. The guide rollers may be adjusted for a particular coating process to ensure optimal coating. Guide rollers may be adjusted manually or through automation using a computer interface. In the case of automation, it is assumed that the roll-to-roll processing equipment is equipped with an automation feature for the guide rollers, in which case the adjustments may be controlled through a computer interface. An interface may be located on the processing equipment or external of the processing equipment. In the event of an external interface, the computer interface may control the automation wirelessly via Wi-Fi or though be wired connection. The number of guide rollers in the roll-to-roll process may range from 1≤N≤100, with a preferred range of 2≤N≤10.

The coating process may be initiated by the rotation of the winding roller pulling the fabric support through the roll-to-roll process. The rotation speed of the winding roller is expected to control the speed or throughput of the coating process. It is assumed that the rotation speed of the winding roller will be controlled through automation using a computer interface. An interface may be located on the processing equipment or external of the processing equipment. In the event of an external interface, the computer interface may control the automation wirelessly via Wi-Fi or though be wired connection. The fabric support may be continuously rolling in which case the ceramic-polymer composite solid-state electrolyte slurry is coated onto and into a moving fabric support.

Coating techniques for a continuously moving fabric support may include, but not limited to, gravure printing, ink jet, slurry casting, doctor blade casting, spraying, knife-over-edge coating, dip coating, slot-die coating, etc. Coating techniques such as slurry casting, doctor blade casting, spraying, knife-over-edge coating, dip coating, and slot-die coating may be used to fabricate a continuous freestanding-flexible solid-state electrolyte membrane onto and into a moving fabric support. In techniques such as slurry casting, doctor blade casting, knife-over-edge, the ceramic-polymer composite solid-state electrolyte slurry may be delivered directly to the fabric support via an external feed. In techniques such as spraying and slot die-coating, the ceramic-polymer composite solid-state electrolyte slurry may be delivered directly to a shower head or printing head via an external feed.

A continuous freestanding-flexible solid-state electrolyte membrane may be in the form of a membrane with no visible regions of excess bare fabric support.

Ink jet printing may be used to print a continuous or patterned freestanding-flexible solid-state electrolyte membrane. The ceramic-polymer composite solid-state electrolyte slurry may be delivered to the ink jet printing head via an external feed. In the instance of a continuous print, the ink jet printer prints the ceramic-polymer composite solid-state electrolyte slurry onto and into the moving fabric support without any interruptions. In the instance of a patterned print, the ink jet printer prints the ceramic-polymer composite solid-state electrolyte slurry at discrete intervals, or timed interruptions, onto and into the fabric support.

A patterned freestanding-flexible solid-state electrolyte membrane may be in the form of a membrane with visible regions of bare fabric support between each print.

Gravure printing may be used to print a patterned or continuous freestanding-flexible solid-state electrolyte membrane. The ceramic-polymer composite solid-state electrolyte slurry may be delivered to a gravure printing slurry tray via external feed. A gravure cylinder is partially immersed into the ceramic-polymer composite solid-state electrolyte slurry. In the instance of a patterned printed, a gravure cylinder has engravements on its surface with a template of the pattern. The wells in the engravements of the gravure cylinder hold the ceramic-polymer composite solid-state electrolyte slurry during printing. The gravure cylinder rotates drawing the slurry onto its surface and into the wells. Said slurry is printed onto and into a moving fabric support by bring the gravure cylinder into contact with said moving fabric support. An impression cylinder located on the opposite side of the fabric support may be brought into contact with said fabric support to apply an external pressure ensuring a uniform print. In the instances of a continuous print, the gravure cylinder may be devoid of engravements on its surface. The gravure cylinder draws slurry onto its surface as it rotates, and prints said slurry onto and into a continuously moving fabric support.

The speed at which the continuously moving fabric support is moving may be governed by the parameters of the coating process. It is assumed that the print speed or the speed of the continuously rolling fabric is controlled by the rotation speed of the winding roller. It is assumed that the rotation speed of the winding roller is controlled through automation using a computer interface. An interface may be located on the processing equipment or external of the processing equipment. In the event of an external interface, the computer interface may control the automation wirelessly via Wi-Fi or though be wired connection.

Alternatively, the fabric support may not be continuously rolling in which case the ceramic-polymer composite solid-state electrolyte slurry is coated onto and into a stationary fabric support. After coating the fabric support is expected to continue rolling for a specific distance and paused again for another coating interval.

Coating techniques for a stationary fabric support may include, but not limited to, screen printing, spraying, and ink jet printing.

In screen printing, the ceramic-polymer composite solid-state electrolyte slurry may be delivered to the screen printer via external feed. The screen printer may be contact with and positioned above the stationary fabric support. A squeegee may transverse the screen printer and be moved laterally along the screen pressing or printing the slurry onto and into the fabric support. After printing is complete the screen printer may be removed from the fabric support surface. The fabric support may be rolled a discrete distance, and the printing process is repeated.

Both spray and ink jet printing may also be used with a continuously rolling fabric support or a stationary fabric support.

Spray, ink jet, and screen-printing techniques may be used to coat a patterned or continuous freestanding flexible solid-state electrolyte membrane.

The coating of a patterned or continuous freestanding-flexible solid-state electrolyte membrane may be governed by the length the fabric support rolls between pausing durations.

Spray, ink jet, and screen-printing coating techniques may also be mobile and move along the path of the fabric support to increase throughput. In this instance, it is expected that the movement of the coating techniques would be controlled through automation using a computer interface. An interface may be located on the processing equipment or external of the processing equipment. In the event of an external interface, the computer interface may control the automation wirelessly via Wi-Fi or though be wired connection.

Multiple spray, ink jet, and screen-printing equipment may be used in the printing process to further increase throughput. It is expected that any movement of the multiple coating equipment will be controlled through automation using a computer interface. An interface may be located on the processing equipment or external of the processing equipment. In the event of an external interface, the computer interface may control the automation wirelessly via Wi-Fi or though be wired connection.

The pause duration of fabric support may be governed by the parameters of the coating process. It is assumed that the pause duration and the length the fabric moves prior to the following pause duration is controlled by the winding roller. It is assumed that the rotation of the winding roller will be controlled through automation using a computer interface. A computer interface may be located on the processing equipment or external of the processing equipment. In the event of an external interface, the computer interface may control the automation wirelessly via Wi-Fi or though be wired connection.

Any and all coating equipment may be controlled manually or through automation, except when automation is specifically mentioned. In the case of automation, it is assumed that the roll-to-roll processing equipment is equipped with an automation feature for the coating equipment. In this instance, the coating equipment may be controlled through automation using a computer interface. An interface may turn the coating process on and off. The interface may control the feed, or the amount/supply of ceramic-polymer composite slurry delivered to the fabric support. The interface may control the duration of a spray of ink printing. The interface may control the rotation of the gravure cylinder and impression cylinder during gravure printing. The interface may control the speed at which the squeegee in screen printing moves. An interface may be located on the processing equipment or external of the processing equipment. In the event of an external interface, the computer interface may control the automation wirelessly via Wi-Fi or though be wired connection.

After coating the fabric support may be rolled into a drying oven to remove the organic solvent. The length of the drying oven and the temperature may be governed by the speed of the moving fabric support and the evaporation properties of the organic solvent. The length of the drying oven may be in the range of 1≤L≤50 meters, with a preferred range of 1≤L≤4 meters. The drying oven may be one continuous drying oven. Alternatively, the drying oven may be multiple drying ovens unit connected to one another. The drying oven or ovens may have a vacuum system pulling the organic solvent vapors out of the roll-to-roll process. Alternatively, the organic solvent can be air dried with a flux of inter gas pushing the vapors out of the roll-to-roll process. The temperature and any vacuum system may be controlled manually or through automation using a computer interface. An interface may be located on the processing equipment or external of the processing equipment. In the event of an external interface, the computer interface may control the automation wirelessly via Wi-Fi or though be wired connection. Guide rollers may be located in the drying oven or ovens to guide the freestanding-flexible solid-state electrolyte membrane.

Removing the solvent may result in a high porosity within the coating. After drying the freestanding-flexible solid-state electrolyte membrane may be calendered to reduce thickness, reduce porosity, and increase density. After calendering the freestanding-flexible solid-state electrolyte membrane may have a porosity less than 20% by total volume of the ceramic-polymer composite solid-state electrolyte, preferably less than 18% by total volume of the ceramic-polymer composite solid-state electrolyte, more preferably less than 16% by total volume of the ceramic-polymer composite solid-state electrolyte, more preferably less than 14% by total volume of the ceramic-polymer composite solid-state electrolyte, more preferably less than 12% by total volume of the ceramic-polymer composite solid-state electrolyte, more preferably less than 10% by total volume of the ceramic-polymer composite solid-state electrolyte, more preferably less than 8% by total volume of the ceramic-polymer composite solid-state electrolyte, more preferably less than 6% by total volume of the ceramic-polymer composite solid-state electrolyte. The amount of porosity after calendering may be controlled by selection of the composition of the ceramic-polymer composite solid-state electrolyte to avoid creation of excessive amounts of porosity in the dried coating and by controlling the calendering process to reduce porosity that results from removal of solvent.

The calendering process can significantly improve the ionic conductivity. Calendering can force the ionic conductive ceramic particles to make intimate contact with one another thus reducing the voids or empty space between them (i.e. porosity). The intimate contact between the ionic conductive ceramic particles can enable better ionic transport between the particles thus increasing the ionic conductivity.

A calendering system may be located within the roll-to-roll process adjacent to the drying oven or ovens. A calendering system consist of two calendering rollers. The distance between the rollers governs the thickness of the freestanding-flexible solid-state electrolyte membrane. A roll-to-roll process may also have more than one calendering system to reach optimal membrane thickness and density. The calendering system or systems may be controlled manually or through automation using a computer interface. In the case of automation, the interface is expected to control the distance between the calendering rollers in the calendering system(s). An interface may be located on the processing equipment or external of the processing equipment. In the event of an external interface, the computer interface may control the automation wirelessly via Wi-Fi or though be wired connection. Alternatively, an external calendering system or systems may be used. In this instance the freestanding-flexible solid-state electrolyte membrane is expected to be directly rolled onto the winding roller following the drying process.

Length of the fabric support in the roll-to-roll process, measured from unwinding roller to winding roller, may be in the range of 2≤L≤100 meters, with a preferred range of 5≤L≤15 meters. The fabric support may have a width in the range of 5≤w≤500 cm, with a preferred range of 10≤w≤100 cm. It is assumed that all guide rollers and tension rollers will have sufficient length to support the fabric support. It is assumed that the unwinding and winding rollers will have sufficient length to support the fabric support. It is assumed that the opening to the drying oven or ovens is sufficiently wide enough to allow the fabric support to roll through. It is assumed that the coating equipment is designed to accommodate the width of the fabric support.

The present description relates to the post processing of the freestanding-flexible solid-state electrolyte membrane. Coating may be terminated by the actions of, but not limited to, stopping the feed or supply of the ceramic-composite solid-state electrolyte slurry, turning off the coating equipment, removing the coating equipment form the surface of the fabric support, etc. The roll-to-roll processing may be terminated by the stoppage of the winding roller. It is assumed that there would be a short duration between the termination of the coating and the roll-to-roll processing to collect the remaining freestanding-flexible solid-state electrolyte membrane. Once the roll-to-roll process is terminated, the fabric support may be cut at any point along the roll-to-roll process. However, it is assumed that the cut will be made adjacent to the winding roller as to limit the waste of fabric support. The spool of freestanding-flexible solid-state electrolyte membrane may be detached and removed from the winding roller. Following the removal of the freestanding-flexible solid-state electrolyte membrane, the fabric support may be reattached to the winding roller, and the roll-to-roll coating process repeated. The detached and removed freestanding-flexible solid-state electrolyte membrane may be further processed. In the event that a roll-to-roll process has a built-in calendering system, the freestanding-flexible solid-state electrolyte membrane may be directly cut to desired dimensions. In the event that a calendering system is absent from the roll-to-roll process, the freestanding-flexible solid-state electrolyte membrane may be calendered using an external calendering system. The freestanding-flexible solid-state electrolyte membrane may be calendered as a whole, and then cut to desired dimensions. Alternatively, the freestanding-flexible solid-state electrolyte membrane may be cut to desired dimensions and then calendered. In this instance, it is expected that the freestanding-flexible solid-state electrolyte membrane will either be used for commercial or research and development purposes. The calendered freestanding-flexible solid-state electrolyte membrane may be cut to desired dimensions using a slitter. The slitter may be automatic in the case of high throughput production, semi-automatic, or manual. The cut freestanding-flexible solid-state electrolyte membrane may be placed onto a winder for the assembly of cylindrical shaped secondary battery cells. The winder may be automatic in the case of high-throughput production, semi-automatic, or manual. The cut freestanding-flexible solid-state electrolyte membrane may be placed onto a winder or stacker for the assembly of prismatic shaped secondary battery cells. The winder or stacker may by automatic in the case of high-throughput production, semi-automatic, or manual. The cut freestanding-flexible solid-state electrolyte membrane may be placed onto a winder or stacker for the assembly of pouch shaped secondary battery cells. The winder or stacker may automatic in the case of high-throughput production, semi-automatic, or manual.

The present disclosure relates to the freestanding-flexible solid-state electrolyte membrane. A solid-state electrolyte membrane is a membrane that selectively allows a specific charged element to pass through under a presence of an electric field or chemical potential, such as concentration differences. A freestanding-flexible solid-state electrolyte membrane may be composed of a fabric support and a ceramic-polymer composite solid-state electrolyte slurry coated onto said fabric support. The present disclosure relates to a fabric support.

A fabric support may be electrically insulating as in the case of a textile-based fabric support. Alternatively, a fabric support may be electrically conductive but with an electronic insulating coating as in the case of a metal-mesh-based fabric support. A fabric support may be highly flexible. A fabric support may be further defined as a highly flexible open cell structure. A textile-based fabric support may have the following characteristics.

A textile-based fabric support may be ionic conductive or nonionic conductive. In an aspect, an ionic conductive textile-based fabric support may have an ionic conductivity of 10⁻⁷ S/cm or greater for the corresponding ion of the solid-state electrolyte membrane. In an aspect, nonionic conductive textile-based fabric support may have an ionic conductivity of less than 10⁻⁷ S/cm for the corresponding ion of the solid-state electrolyte membrane. A textile-based fabric support may have a thickness ranging from 0.01<t<1000 μm, with a preferred thickness of 0.1<t<500 μm.

Fabrication approaches for a textile-based fabric support may include, but not limited to, weaving, knitting, crocheting, knotting, tatting, felting, braiding, electrospinning, electrospraying, and 3D-printing. In some instances, the textile-based fabric support may be non-woven. In other instances the textile-based fabric support may be a woven structure. The textile-based fabric support may be made from natural fibers or synthetic fibers.

Natural fibers may include, but not limited to, cotton, stem or bast fibers such as flax or hemp; leaf fibers such as sisal; husk fibers such as coconut; and animal fibers such as wool, silk, cashmere, chitin, chitosan, collagen, keratin and furs.

Synthetic fibers may include, but not limited to, polyesters, polyimides (PI), polyolefins, polyvinyl chloride (PVC), polyvinylidene chloride (PVDC), poly(methyl methacrylate) (PMMA), polyvinylidene fluoride (PVDF), polyether-polyurea copolymer, polyvinyl alcohol (PVA), polybenzimidazole, polyacrylonitrile (PAN), polyphenylene sulfide (PPS), poly(lactic acid), polyhydroquinone-diimidazopyridine, polyparaphenylene benzobisthiazole (PBT), polyparaphenylene benzobisimidazole (PBI), polyethylene terephthalate (PET), polyparaphenylenebenzobisoxazole (PBO), poly(p-phenylene-2,6-benzobisoxazole), Kevlar, 6-nylon, 66-nylon, acrylic fibers, cellulose fibers and polyethylene naphthalate, polyether ether ketone, modified polyphenylene ether (PPE), glass fibers, fiberglass, other liquid crystal polymers and mixtures using these two or more.

The textile-based fabric support may be composed of common textiles which may include, but not limited to, satin, denim, crepel, fleece, polyester, linen, velvet, damas, cheesecloth, chiffon, rayon, baize, batiste, chameuse, chenille, cheviot, felt, twill, velvet, jersey, lace, lycra, polycotton, etc.

A textile-based fabric support has sufficient mechanical strength to withstand any applied forces that may be necessary in the roll-to-roll process. A textile-based fabric support has sufficient mechanical strength to withstand applied forces during secondary battery integration and cell assembly. Such cell assemblies include, but not limited to, pouch, cylindrical, and prismatic type secondary batteries.

A metal-mesh-based fabric support may have the following characteristics. A metal mesh-based fabric support may be ionic conductive or nonionic conductive. In an aspect, an ionic conductive metal mesh-based fabric support may have an ionic conductivity of 10⁻⁷ S/cm or greater for the corresponding ion of the solid-state electrolyte membrane. In an aspect, nonionic conductive metal mesh-based fabric support may have an ionic conductivity of less than 10⁻⁷ S/cm for the corresponding ion of the solid-state electrolyte membrane. A metal mesh-based fabric support may have a thickness ranging from 0.01<t<1000 μm, with a preferred thickness of 0.1<t<500 μm.

A metal mesh-based fabric support may be composed of, but not limited to, copper, aluminum, stainless steel, nickel, titanium, vanadium, iron, cobalt, zinc, molybdenum, niobium, etc. In some instances the metal mesh-based fabric support may be a metal alloy wherein two or more metals are used in the support structure. In yet another instance a metal nesh or metal alloy mesh fabric support may be doped with a non-metal element. The metal alloy or a doping of a non-metal element may be used to decrease the electronic conductivity of the fabric support

A metal mesh-based fabric support may be conformally coated with an electronic insulating layer as to avoid short circuiting. The electronic insulating layer may have a thickness in the range of 1<t<1000 nm, with a preferred thickness of 5<t<100 nm. An insulating layer may be composed of, but not limited to, polymer, metal oxide, or ceramic.

A metal mesh-based fabric support has sufficient mechanical strength to withstand any applied forces that may be necessary in the roll-to-roll process. A metal mesh-based fabric support has sufficient mechanical strength to withstand applied forces during secondary battery integration and cell assembly. Such cell assemblies include, but not limited to, pouch, cylindrical, and prismatic type secondary batteries.

The form of a metal mesh-based fabric includes any highly flexible porous metal structure, including a wire-based structure or an open cell structure. Fabrication approaches for a metal mesh-based fabric support may include, but not limited to, welding, weaving, and 3D-printing.

The present disclosure relates to a ceramic-polymer composite solid-state electrolyte slurry. A ceramic-polymer composite solid-state electrolyte slurry is used in the formation of a freestanding-flexible solid-state electrolyte membrane by coating said slurry onto a fabric support. A ceramic-polymer composite solid-state electrolyte slurry has sufficient viscosity for uniform coating on to the fabric support. A ceramic-polymer composite solid-state electrolyte slurry may be composed of an organic solvent, polymer, ionic conducting salt, and an ionic-conductive ceramic. An organic solvent may have the following characteristics

The organic solvent may be ionic conductive or nonionic conductive. In an aspect, an ionic conductive organic solvent may have an ionic conductivity of 10⁻⁷ S/cm or greater for the corresponding ion of the solid-state electrolyte membrane. In an aspect, nonionic conductive organic solvent may have an ionic conductivity of less than 10⁻⁷ S/cm for the corresponding ion of the solid-state electrolyte membrane.

Organic solvents may include, but not limited to, ethanol, methanol, acetone, hexane, chloroform, dimethylformamide, benzene, toluene, etc. The organic solvent may be used to adjust the viscosity of the ceramic-polymer composite solid-state electrolyte slurry to fully penetrate the fabric support. However, the viscosity may not be too low as to fall through the fabric support resulting in an uneven coating. The organic solvent is chemically compatible with the ionic conductive ceramic.

A polymer may have the following characteristics. A polymer may be ionic conducting polymers or nonionic conducting polymers. In an aspect, an ionic conductive polymer may have an ionic conductivity of 10⁻⁷ S/cm or greater for the corresponding ion of the solid-state electrolyte membrane. In an aspect, nonionic conductive polymer may have an ionic conductivity of less than 10⁻⁷ S/cm for the corresponding ion of the solid-state electrolyte membrane. The ionic conducting polymers may be advantageous because they may directly provide ionic conductivity to the composite membrane. The nonionic conducting polymers may be advantageous because they allow for higher loading of the ionic-conductive ceramic thereby they may indirectly provide ionic conductivity to the composite membrane. Moreover, the nonionic conducting polymers may offer better non-expandable properties restricting volume changes leading to a more stabilized electrode/electrolyte interface. The polymer may be dissolved in the organic solvent.

Examples of polymers included, but not limited to, polyethylene glycol, polyisobutene (e.g. OPPANOL™), polyvinylidene fluoride, polyvinyl alcohol. Additional examples of suitable polymer include, but are not limited to, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ε-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), polypropylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ε-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK).

An ionic conducting salt may have the following characteristics. In an aspect, an ionic conductive salt may have an ionic conductivity of 10⁻⁷ S/cm or greater for the corresponding ion of the solid-state electrolyte membrane. An ionic conducting salt may fully dissociate in the organic solvent. Alternatively, the ionic conducting salt may partially dissociate in the organic solvent. Examples of ionic conducting salts may include, but not limited to, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, Li N(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

An ionic-conductive ceramic may have the following characteristics. An ionic-conductive ceramic includes or is formed from a solid-state ionic conductive material. A solid-state ionic conductive material can be described as a material that may have the following characteristics. A solid-state ionic conductive material is a type of material that can selectively allow a specific charged element to pass through under a presence of an electric field or chemical potential, such as concentration differences. While this solid-state ionic conductive material allows ions to migrate through, it may not allow electrons to pass easily. The ions may carry 1, 2, 3, 4 or more positive charges. Examples of the charged ions include but not limited to H⁺, Li⁺, Na⁺, K⁺, Mg²⁺, Al³⁺, Zn²⁺, etc. The ionic conductivity is preferably to be 10⁻⁷ S/cm or greater for the corresponding ion of the solid-state electrolyte membrane. It is preferably to have lower electronic conductivity (10⁻⁷ S/cm or less).

Examples of the solid-state ionic conductive material include but not limited to a garnet-like structure oxide material with the general formula:

Liₙ[A(_{3-a′-a″)}A′(_{a′})A″(_{a″})][B(_{2-b′-b″})B′(_{b′})B″(_{b″})][C′(_{c′})C″(C_{c″})]O₁₂,

a. where A, A′, and A″ stand for an dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;

b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;

c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and

d. wherein n=7+a′+2·a″−b′−2·b″−3·c′−4·c″ and 4.5≤n≤7.5.

In another example, a solid-state ionic conductive material includes perovskite-type oxides such as (Li,La)TiO₃ or doped or replaced compounds. In yet another example, a solid-state ionic conductive material includes NASICON-structured lithium membrane, such as LAGP (Li₁₋ₓAlₓGe₂₋ₓ(PO₄)₃), LATP (Li₁₋ₓ+xAlₓTi₂₋ₓ(PO₄)₃) and these materials with other elements doped therein. In yet another example, a solid-state ionic conductive material includes anti-perovskite structure materials and their derivatives, such as the composition of Li₃OCl, Li₃OBr, Li₃OI. In yet another example, a solid-state ionic conductive material includes Li₃YH₆(H═F, Cl, Br, I) family of materials, Y can be replaced by other rare earth elements. In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof. In yet another example, a solid-state ionic conductive material includes argyrodites materials with the general formula: Li₁₂₋ₘ₋ₓ(MₘY₄²⁻)Y₂₋ₓ²⁻Xₓ⁻, wherein Mₘ₊=B³⁺, Sb³⁺, Si⁴⁺, Ge⁴⁺, P⁵⁺, As⁵⁺, or a combination thereof; Y²⁻═O²⁻, S²⁻, Se²⁻, Te²⁻, or a combination thereof; X⁻═F⁻, Cl⁻, Br⁻, I⁻, or a combination thereof; and x is in the range of 0≤x≤2.

In an aspect, ionic conductive ceramic particles have a particle size in the range of 0.001<d<100 μm, preferably in the range of 0.1<d<10 μm. The particle size can be determined as D50 mass-median-diameter. In an aspect, the ionic conductive ceramic particles have a bimodal size distribution. In an aspect, ionic conductive ceramic particles have a morphology including one or more of nanoparticles, cubes, nanocubes, fibers, nanofibers, wires, nanowires, quantum dots, nanotubes, and octahedrons. The ionic conductive ceramic may be present in a range of from greater than 0% to less than 100% by mass of the total mass of the ceramic-polymer composite solid-state electrolyte, preferably in a range of from 80% to 99.99% by mass of the total mass of the ceramic-polymer composite solid-state electrolyte, more preferably in a range of from 90% to 99.9% by mass of the total mass of the ceramic-polymer composite solid-state electrolyte, more preferably in a range of from 95% to 99.5% by mass of the total mass of the ceramic-polymer composite solid-state electrolyte.

After calendering, the ionic conductive ceramic may be present in a range of from greater than 0% to less than 100% by volume of the total volume of the ceramic-polymer composite solid-state electrolyte, preferably in a range of from 50% to 99.99% by volume of the total volume of the ceramic-polymer composite solid-state electrolyte, more preferably in a range of from 60% to 99.95% by volume of the total volume of the ceramic-polymer composite solid-state electrolyte, more preferably in a range of from 70% to 99.9% by volume of the total volume of the ceramic-polymer composite solid-state electrolyte, more preferably in a range of from 80% to 99.5% by volume of the total volume of the ceramic-polymer composite solid-state electrolyte, more preferably in a range of from 85% to 99% by volume of the total volume of the ceramic-polymer composite solid-state electrolyte. The volume percent of ionic conductive ceramic within the total volume of the ceramic-polymer composite solid-state electrolyte is determined by the initial mass loading of the ionic conductive ceramic and the avoidance and reduction of porosity within the ceramic-polymer composite solid-state electrolyte. Thus, the volume percent of ionic conductive ceramic changes upon densification of the ceramic-polymer composite solid-state electrolyte such as by the process of calendering. A high-volume percent of ionic conductive ceramic facilitates intimate contact between adjacent particles of ionic conductive ceramic. The intimate contact between the ionic conductive ceramic particles can enable better ionic transport between the particles thus increasing the ionic conductivity. In some instances, the polymer may chemically react with the ionic conductive ceramics to improve ionic conductivity.

In some instances, nonionic conducting additives may be added to the ceramic-polymer composite slurry. Nonionic conductive additives may include, but not limited to, inorganics such as alumina, titania, lanthanum oxide or zirconia; epoxies, resins, plasticizers, surfactants, binders, etc.

The present disclosure relates to a freestanding-flexible solid-state electrolyte membrane. A freestanding-flexible solid-state electrolyte membrane may have a thickness in the range of 1<t<1000 μm, with a preferred range of 10<t<100 μm. A lower thickness reduces the distance ions travel thus improving battery performance metrics such as power rates. In an aspect, a ratio of a thickness of the solid-state electrolyte membrane to a thickness of the fabric support is in a range of from greater than 1 to 5, preferably in a range of from greater than 1 to 2, more preferably in range of from greater than 1 to 1.5, more preferably in a range of from greater than 1 to 1.2. When the solid-state electrolyte membrane has a thickness that is approximately the same as the thickness of the fabric support, the solid-state electrolyte membrane is structurally beneficially supported by the fabric support. A freestanding-flexible solid-state electrolyte membrane may have a room temperature ionic conductivity of 10⁻⁷ S/cm or greater.

The freestanding-flexible solid-state electrolyte membrane may have sufficient flexibility to withstand applied forces during the roll-to-roll processing. The freestanding-flexible solid-state electrolyte membrane may have sufficient mechanical strength to withstand applied forced during the roll-to-roll processing. The freestanding-flexible solid-state electrolyte membrane may have sufficient flexibility and mechanical strength to withstand applied forces during secondary battery integration and cell assembly. Such cell assemblies may include, but not limited to, pouch, cylindrical, and prismatic type secondary batteries. The freestanding-flexible solid-state electrolyte membrane may have sufficient mechanical strength and other properties to block metal dendrite formation during secondary battery operation. The solid-state electrolytes may prevent or reduce dendrite penetration. To improve blocking capability, composite membrane structures may have high density, i.e. low porosity. Porosity detrimentally gives the lithium dendrites more open space (voids) to propagate through. Calendering reduces porosity and also results in a smoother surface. Having a smoother surface enables better contact with the lithium metal. This better contact may improve charge distribution uniformity making dendrite propagation difficult during plating/stripping cycles. The composite membrane structure may have an improved ability to block dendrite formation. The inorganic ceramics are much smaller resulting in the reduction or in some cases the elimination of grain boundaries. The limited space between them is filled with polymer, and though the mechanical strength is lower, it still has some pentation blocking capabilities. In other words, the composite makes it more difficult for lithium dendrites to penetrate through.

The present disclosure relates to a secondary battery. A secondary battery may be defined as a battery that can be recharged and not limited to one discharge cycle. Secondary batteries may be in the form of, but not limited to, ion-based batteries or metal batteries. Secondary batteries may be in the shape or orientation of, but not limited to, pouch, cylindrical, or prismatic type cells. Types of secondary batteries may include, but not limited to, lithium ion batteries, sodium ion batteries, magnesium ion batteries, aluminum ion batteries, potassium ion batteries, zinc ion batteries, lithium metal batteries, sodium metal batteries, magnesium metal batteries, aluminum metal batteries, potassium metal batteries, zinc metal batteries, nickel cadmium battery, nickel-metal hydride battery, glass battery, lithium-ion polymer, lithium-sulfur battery, sodium sulfide battery, zinc-bromide battery, and lithium titanate battery.

A secondary battery may be a solid-state secondary battery which consist of an composite cathode, composite anode or metal/metal-alloy anode, and a freestanding-flexible solid-state electrolyte membrane. Alternatively, a secondary battery may be a semi-solid-state secondary battery which consist of a cathode or composite cathode, an anode or composite anode or metal/metal-alloy anode, a flexible solid-state electrolyte membrane, and a liquid-based electrolyte.

The present disclosure relates to a secondary battery cathode. A secondary battery cathode or composite cathode may be coated with a thin protective layer on the surface to enhance stability and reduce interface resistance with the freestanding-flexible solid-state electrolyte membrane. A cathode may have the following characteristics. A cathode may be comprised of, but not limited to, an active intercalation material, binder, and an electrically conductive additive. A cathode may contain an active intercalation material such as, but not limited to, layered YMO₂, Y-rich layered Y₁₊ₓM₁₋ₓO₂, spinel YM₂O₄, olivine YMPO₄, silicate Y₂MSiO₄, borate YMBO₃, tavorite YMPO₄F (where M is Fe, Co, Ni, Mn, Cu, Cr, etc.), (where Y is Li, Na, K etc.), vanadium oxides, sulfur, lithium sulfide FeF₃, LiSe. In the case of a lithium intercalation, cathodes may include, but not limited to, lithium iron phosphate (LiFePO₄), lithium cobalt oxide (LiCoO₂), lithium manganese oxide (LiMn₂O₄), and lithium nickel oxide (LiNiO₂), lithium nickel cobalt manganese oxide (LiNiₓCo_{y}Mn_{z}O₂, 0.95≥x≥0.5, 0.3≥y≥0.025, 0.2≥z≥0.025), lithium nickel cobalt aluminum oxide (LiNiₓCo_{y}Al_{z}O₂, 0.95≥x≥0.5, 0.3≥y≥0.025, 0.2≥z≥0.025), lithium nickel manganese spinel (LiNi_{0.5}Mn_{1.5}O₄), etc. A cathode may include a binder such as, but not limited to, polyvinylidene fluoride, polyacrylic acid, lotader, carboxymethyl cellulose, styrene-butadiene rubber, sodium alginate, etc. A cathode may include an electrically conductive additive such as, but not limited to, graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), polyphenylene vinylene, etc.

A composite cathode may have the following characteristics. A composite cathode may be comprised of, but not limited to, an active intercalation material, binder, electrically conductive additive, and an ionic conducting media. A composite cathode may contain an active intercalation material such as, but not limited to, layered YMO₂, Y-rich layered Y₁₊ₓM₁₋ₓO₂, spinel YM₂O₄, olivine YMPO₄, silicate Y₂MSiO₄, borate YMBO₃, tavorite YMPO₄F (where M is Fe, Co, Ni, Mn, Cu, Cr, etc.), (where Y is Li, Na, K etc.), vanadium oxides, sulfur, lithium sulfide FeF₃, LiSe. In the case of a lithium intercalation, composite cathodes may include, but not limited to, lithium iron phosphate (LiFePO₄), lithium cobalt oxide (LiCoO₂), lithium manganese oxide (LiMn₂O₄), and lithium nickel oxide (LiNiO₂), lithium nickel cobalt manganese oxide (LiNiₓCo_{y}Mn_{z}O₂, 0.95≥x≥0.5, 0.3≥y≥0.025, 0.2≥z≥0.025), lithium nickel cobalt aluminum oxide (LiNiₓCo_{y}Al_{z}O₂, 0.3≥y≥0.025, 0.2≥z≥0.025), lithium nickel manganese spinel (LiNi_{0.5}Mn_{1.5}O₄), etc. A composite cathode may include a binder such as, but not limited to, polyvinylidene fluoride, polyacrylic acid, carboxymethyl cellulose, styrene-butadiene rubber, sodium alginate, etc. A composite cathode may include an electrically conductive additive such as, but not limited to, graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), polyphenylene vinylene, etc.

The ionic conducting media in a composite cathode may include, but not limited to, a polymer, ionic-conductive ceramic, or polymer-ceramic composite. A polymer in a composite cathode may include an ionic conducting or nonionic conducting polymer. In an aspect, an ionic conductive polymer may have an ionic conductivity of 10⁻⁷ S/cm or greater for the corresponding ion of the solid-state electrolyte membrane. In an aspect, nonionic conductive polymer may have an ionic conductivity of less than 10⁻⁷ S/cm for the corresponding ion of the solid-state electrolyte membrane. Examples of polymers may include, but not limited to, polyethylene glycol, polyisobutene (e.g. OPPANOL™) polyvinylidene fluoride, polyvinyl alcohol. Additional examples of suitable polymer include, but are not limited to, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ε-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ε-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK).

For a nonionic polymer, an ionic conductive salt may be added. Examples of ionic conducting salts may include, but not limited to, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

An ionic conductive ceramic used in a composite cathode may have the following characteristics. An ionic conductive ceramic includes or is formed from a solid-state ionic conductive material. A solid-state ionic conductive material can be described as a material that may have the following characteristics. A solid-state ionic conductive material is a type of material that can selectively allow a specific charged element to pass through under a presence of an electric field or chemical potential, such as concentration differences. While this solid-state ionic conductive material allows ions to migrate through, it may not allow electrons to pass easily. The ions may carry 1, 2, 3, 4 or more positive charges. Examples of the charged ions include but not limited to H⁺, Li⁺, Na⁺, K⁺, Ag⁺, Mg²⁺, Al³⁺, Zn²⁺, etc. The ionic conductivity of the corresponding ions is preferably to be 10⁻⁷ S/cm or greater. It is preferably to have lower electronic conductivity (10⁻⁷ S/cm or less). Examples of the solid-state ionic conductive material include but not limited to a garnet-like structure oxide material with the general formula:

Liₙ[A(_{3-a′-a″)}A′(_{a′})A″(_{a″})][B(_{2-b′-b″})B″(_{b′})B″(_{b″})][C′(_{c′})C″(_{c″})]O₁₂,

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;

b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;

c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and

d. wherein n=7+a′+2·a″−b′−2·b″−3·c′−4·c″ and 4.5≤n≤7.5.

In another example, a solid-state ionic conductive material includes perovskite-type oxides such as (Li,La)TiO₃ or doped or replaced compounds. In yet another example, a solid-state ionic conductive material includes NASICON-structured lithium membrane, such as LAGP (Li₁-xAlₓGe₂₋ₓ(PO₄)₃), LATP (Li₁+xAlₓTi₂₋ₓ(PO₄)₃) and these materials with other elements doped therein. In yet another example, a solid-state ionic conductive material includes anti-perovskite structure materials and their derivatives, such as the composition of Li₃OCl, Li₃OBr, Li₃OI. In yet another example, a solid-state ionic conductive material includes Li₃YH₆(H═F, Cl, Br, I) family of materials, Y can be replaced by other rare earth elements. In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof. In yet another example, a solid-state ionic conductive material includes argyrodites materials with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻═O²⁻, S²⁻, Se²⁻, Te²⁻, or a combination thereof; X⁻═F⁻, Cl⁻, Br⁻, I⁻, or a combination thereof; and x is in the range of 0≤x≤2. In an aspect, solid-state ionic conductive material particles have a particle size in the range of 0.001<d<100 μm, preferably in the range of 0.1<d<10 μm. In an aspect, solid-state ionic conductive material particles have a morphology including one or more of nanoparticles, cubes, nanocubes, fibers, nanofibers, wires, nanowires, quantum dots, nanotubes, and octahedrons.

The present disclosure relates to a secondary battery anode. A secondary battery anode, metal/metal-alloy anode, or composite anode may be coated with a thin layer on the surface to enhance stability and reduce interface resistance with the freestanding-flexible solid-state electrolyte membrane. An anode may have the following characteristics. In the case of an ion-based secondary battery an anode may also comprise of, but not limited to, an active material, binder, and electrically conductive additive. Active materials may interact with ions through various mechanisms including, but not limited to, intercalation, alloying and conversion. An active material anode material may include, but not limited to, titanium oxide, silicon, tin oxide, germanium, antimony, silicon oxide, iron oxide, cobalt oxide, ruthenium oxide, molybdenum oxide, molybdenum sulfide, chromium oxide, nickel oxide, manganese oxide, carbon-based materials (hard carbons, soft carbons, graphene, graphite's, carbon nanofibers, carbon nanotubes, etc.). An anode may include a binder such as, but not limited to, polyvinylidene fluoride, polyacrylic acid, carboxymethyl cellulose, styrene-butadiene rubber, sodium alginate, etc. An anode may include an electrically conductive additive such as, but not limited to, graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), polyphenylene vinylene etc.

A metal/metal alloy anode may have the following characteristics. In the case of a metal-based secondary battery a negative electrode may comprise of a metal or metal alloy. Metal/metal-alloy anodes may interact with ions through a plating and stripping mechanism. Such a negative electrode may be comprised of, but not limited to, lithium metal, lithium metal alloy, sodium metal, sodium metal alloy, magnesium metal, magnesium metal alloy, aluminum metal, aluminum metal alloy, potassium metal, potassium metal alloy, zinc metal, zinc metal alloy. Alloys may include materials such as, but not limited to, indium, manganese, etc.

A composite anode may have the following characteristics. Generally, a composite anode is used in an ion-based secondary battery. Composite anodes are composed of an active material, binder, electrically conductive additive, and an ionic conductive media. Active materials may interact with ions through various mechanisms including, but not limited to, intercalation, alloying and conversion. An active material anode material may include, but not limited to, titanium oxide, silicon, tin oxide, germanium, antimony, silicon oxide, iron oxide, cobalt oxide, ruthenium oxide, molybdenum oxide, molybdenum sulfide, chromium oxide, nickel oxide, manganese oxide, carbon-based materials (hard carbons, soft carbons, graphene, graphite's, carbon nanofibers, carbon nanotubes, etc.). A composite anode may include a binder such as, but not limited to, polyvinylidene fluoride, polyacrylic acid, carboxymethyl cellulose, styrene-butadiene rubber, sodium alginate, etc. A composite anode may include an electrically conductive additive such as, but not limited to, graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), polyphenylene vinylene etc. The ionic conducting media in a composite anode may include, but not limited to, a polymer, ionic-conductive ceramic, or polymer-ceramic composite.

A polymer used in a composite anode may be an ionic conducting or nonionic conducting polymer. Examples of polymers may include, but not limited to, polyethylene glycol, polyisobutene (e.g. OPPANOL™), polyvinylidene fluoride, polyvinyl alcohol. Additional examples of suitable polymer include, but are not limited to, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ε-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ε-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK).

In the case of a nonionic polymer, an ionic conductive salt may be added. Examples of ionic conducting salts may include, but not limited to, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

An ionic conductive ceramic used in a composite anode may have the following characteristics. An ionic conductive ceramic includes or is formed from a solid-state ionic conductive material. A solid-state ionic conductive material can be described as a material that may have the following characteristics. A solid-state ionic conductive material is a type of material that can selectively allow a specific charged element to pass through under a presence of an electric field or chemical potential, such as concentration differences. While this solid-state ionic conductive material allows ions to migrate through, it may not allow electrons to pass easily. The ions may carry 1, 2, 3, 4 or more positive charges. Examples of the charged ions include but not limited to H⁺, Li⁺, Na⁺, K⁺, Ag⁺, Mg²⁺, Al³⁺, Zn²⁺, etc. The ionic conductivity of the corresponding ions is preferably to be 10⁻⁷ S/cm or greater. It is preferably to have lower electronic conductivity (10⁻⁷ S/cm or less). Examples of the solid-state ionic conductive material include but not limited to a garnet-like structure oxide material with the general formula:

Liₙ[A(_{3-a′-a″)}A′(_{a′})A″(_{a″})][B(_{2-b′-b″})B′(_{b′})B″(_{b″})][C′(_{c′})C″(_{c″})]O₁₂,

a. where A, A′, and A″ stand for an dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;

b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;

c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and

d. wherein n=7=a′+2·a″−b′−2·b″−3·c′−4·c″ and 4.5≤n≤7.5.

In another example, a solid-state ionic conductive material includes perovskite-type oxides such as (Li,La)TiO₃ or doped or replaced compounds. In yet another example, a solid-state ionic conductive material includes NASICON-structured lithium membrane, such as LAGP (Li₁-xAlₓGe₂₋ₓ(PO₄)₃), LATP (Li₁+xAlₓTi₂₋ₓ(PO₄)₃) and these materials with other elements doped therein. In yet another example, a solid-state ionic conductive material includes anti-perovskite structure materials and their derivatives, such as the composition of Li₃OCl, Li₃OBr, Li₃OI. In yet another example, a solid-state ionic conductive material includes Li₃YH₆(H═F, Cl, Br, I) family of materials, Y can be replaced by other rare earth elements. In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof. In yet another example, a solid-state ionic conductive material includes argyrodites materials with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻═O²⁻, S²⁻, Se²⁻, Te²⁻, or a combination thereof; X⁻═F⁻, Cl⁻, Br⁻, I⁻, or a combination thereof, and x is in the range of 0≤x≤2. In an aspect, solid-state ionic conductive material particles have a particle size in the range of 0.001<d<100 μm, preferably in the range of 0.1<d<10 μm. In an aspect, solid-state ionic conductive material particles have a morphology including one or more of nanoparticles, cubes, nanocubes, fibers, nanofibers, wires, nanowires, quantum dots, nanotubes, and octahedrons.

The present disclosure relates to a liquid-based electrolyte in a semi-solid-state secondary battery. Liquid-based electrolytes may include, but not limited to, an organic-based liquid electrolyte or a room temperature ionic liquid electrolyte. Examples of organic-based liquid electrolyte may include, but not limited to, ethylene carbonate (EC), fluoroethylene carbonate (FEC), propylene carbonate (PC), ethyl-methyl carbonate (EMC), dimethyl carbonate (DMC), diethyl carbonate (DEC), dimethyl ether (DME), diethylene glycol dimethyl ether (DEGDME), tetraethylene glycol dimethyl ether (TEGDME), 1,3-dioxolane (DOL), and 1-ethyl-3-methylimidoxzoium chloride and the mixtures of two or more of them. Examples of room temperature ionic liquid electrolyte may include, but not limited to, imidazolium, pyrrolidinium, piperidinium, ammonium, hexafluorophosphate, dicyanamide, tetrachloroaluminate, sulfonium, phosphonium, pyridinium, parazonium and thiazolium. An organic-based liquid electrolyte and a room temperature ionic liquid electrolyte may include an ionic conducting salt. Examples of ionic conducting salts may include, but not limited to, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)4, LiPF₆, LiC(SO₂CF₃)₃, LiN(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

The drawings of the present disclosure further describe examples of processing methods for freestanding-flexible solid-state electrolyte membranes and their use in solid-state and semi-solid-state secondary batteries.

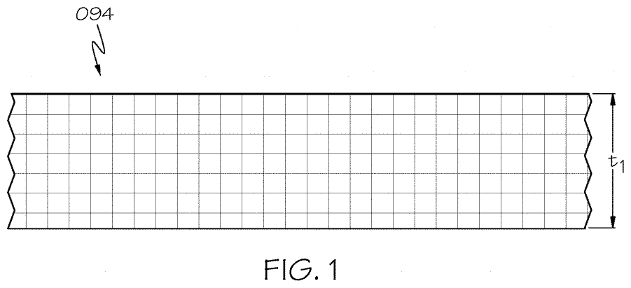

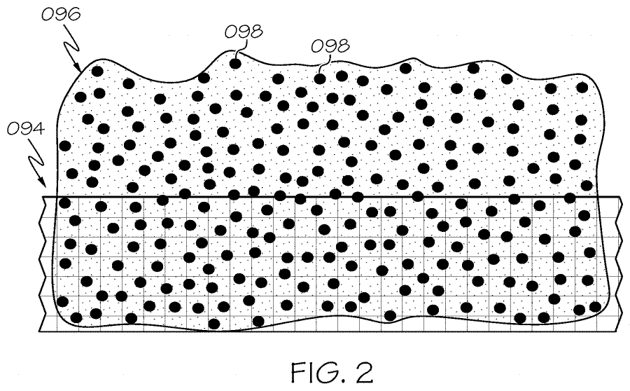

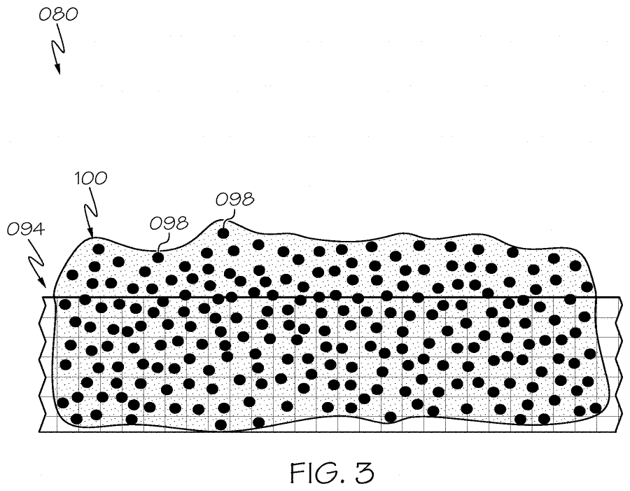

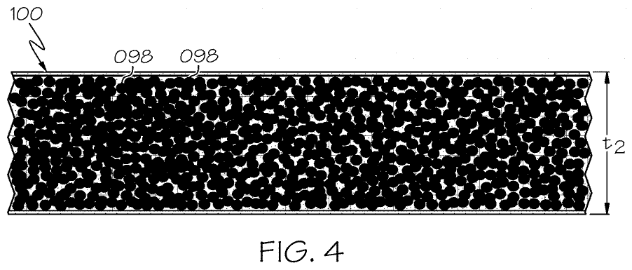

FIG. 1 is a representation of a cross-section of a fabric support 094 having a thickness ti according to the present disclosure. The fabric support 094 may have any one or more features of the fabric support as previously described. FIG. 2 is a representation of a cross-section of the fabric support 094 of FIG. 1 after coating with a slurry comprising particles of ionic conductive ceramic 098 in a mixture of solvent, a polymer, and an ionic conducting salt 096. Although the particles of ionic conductive ceramic 098 is illustrated as having a uniform size, the size of the particles of ionic conductive ceramic 098 may have various different sizes and shapes. FIG. 3 is a representation of a cross-section of the fabric support 094 of FIG. 2 after drying to form a solid-state electrolyte membrane 080. The solid-state electrolyte membrane 080 includes ionic conductive ceramic 098 in a mixture of polymer and an ionic conducting salt 100 on fabric support 094. Although not illustrated, the mixture of polymer and an ionic conducting salt 100 would typically include significant amounts of porosity as a result of the evaporation of the solvent. FIG. 4 is a representation of a cross-section of the solid-state electrolyte membrane of FIG. 3 after densification (e.g. calendering) of the solid-state electrolyte membrane 080. The solid-state electrolyte membrane 080 includes ionic conductive ceramic 098 in a mixture of polymer and an ionic conducting salt 100 on fabric support 094, in which much of the ionic conductive ceramic 098 is pressed in intimate contact or close proximity with each other. The resulting thickness t₂ of the solid-state electrolyte membrane 080 is preferably slightly greater than the thickness t₁ of the fabric support 094. Preferably, a ratio of the thickness of the solid-state electrolyte membrane t₂ to the thickness of the fabric support t₁ is in a range of from greater than 1 to 1.2. Calendering can preferably result in close proximity or intimate contact between particles of ionic conductive ceramic 098 and a thickness of the solid-state electrolyte membrane that is similar to a thickness of the fabric support.

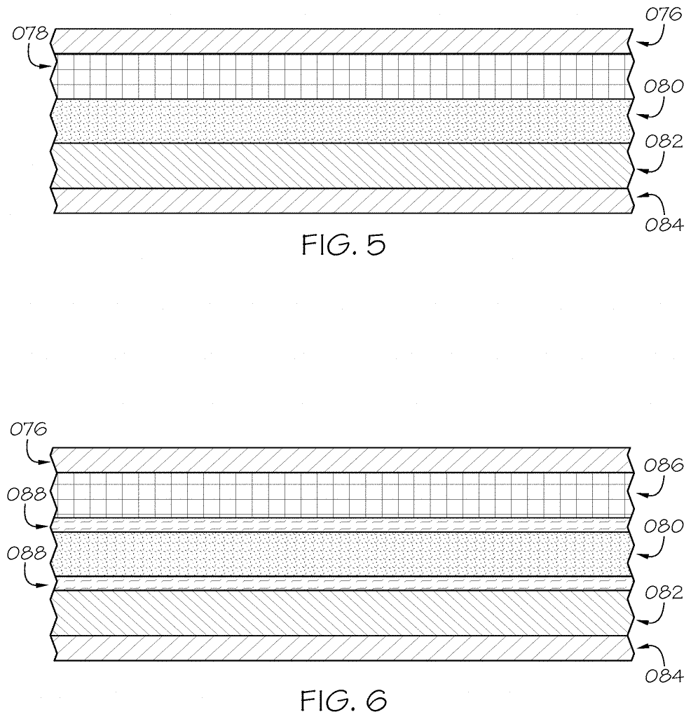

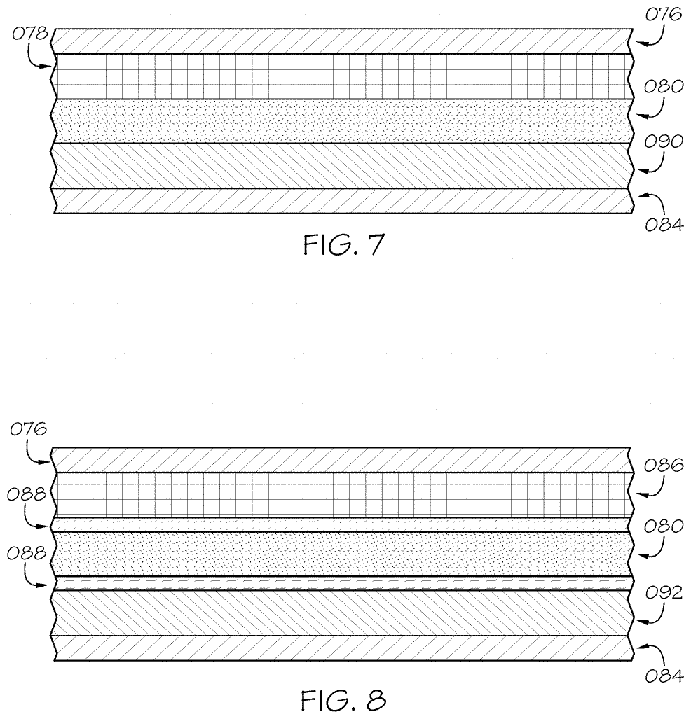

FIG. 5: A schematic illustration of a solid-state secondary metal battery using the freestanding-flexible solid-state electrolyte membrane 080, a composite cathode 086, and a metal/metal-alloy anode 082. FIG. 6: A schematic illustration of a semi-solid-state secondary metal battery using the freestanding-flexible solid-state electrolyte membrane 080, a cathode 086, a metal/metal-alloy anode 082, and a liquid-based electrolyte 088. FIG. 7: A schematic illustration of a solid-state secondary battery using the freestanding-flexible solid-state electrolyte membrane 080, a composite cathode 078, and a composite anode 090. FIG. 8: A schematic illustration of a semi-solid-state secondary battery using the freestanding-flexible solid-state electrolyte membrane 080, a cathode 086, an anode 092, and a liquid-based electrolyte 088.

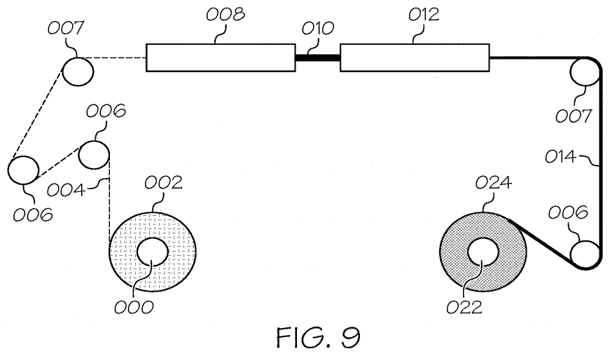

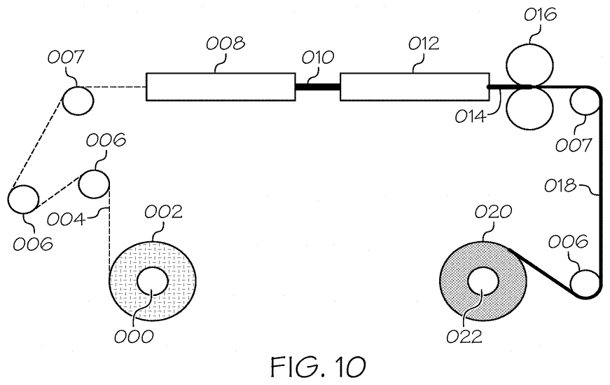

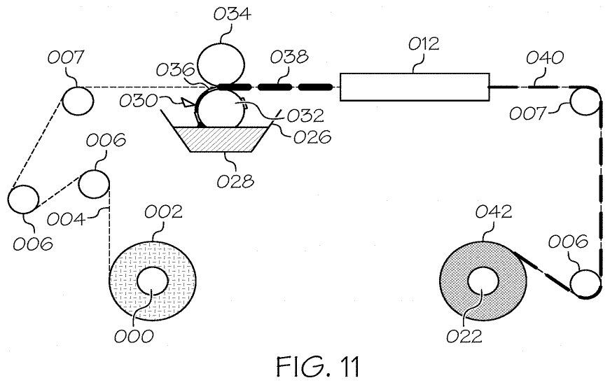

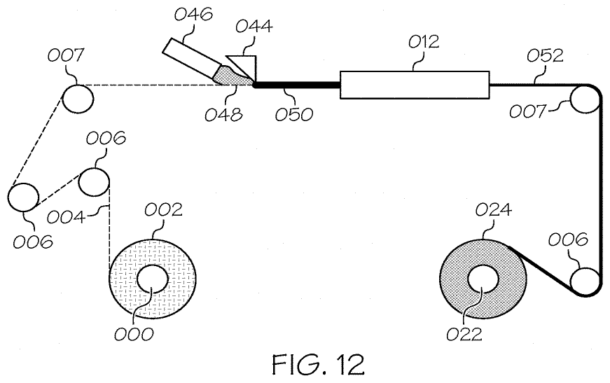

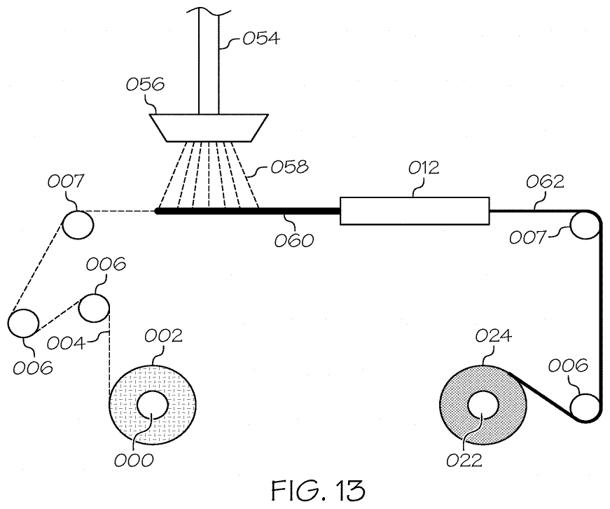

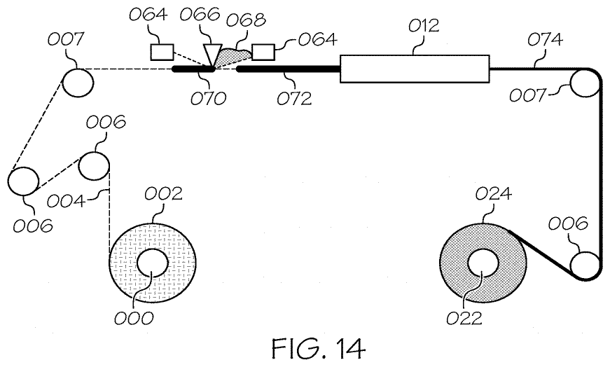

FIG. 9: A schematic illustration of the roll-to-roll process without a calendering system incorporated within. The schematic illustration is just one example of where the unwinding roller 000 with fabric spool positioned on to 002, tensions rollers 006, guide rollers 007, location of coating equipment 008, drying oven 012, and a winding roller 022 with a spool of uncalendered freestanding-flexible solid-state electrolyte membrane 024 rolled onto, may be positioned. The schematic illustration also shows the general path a fabric support 004, an as coated membrane 010, and a dried freestanding-flexible solid-state electrolyte membrane 014 may take through such a roll-to-roll process.

FIG. 10: A schematic illustration of a roll-to-roll process with a calendering system 016 incorporated into the process to form a spool 020 of calendered freestanding-flexible solid-state electrolyte membrane 018. The schematic illustration is just one example of where the unwinding roller 000 with fabric spool positioned on to 002, tensions rollers 006, guide rollers 007, coating equipment 008, drying oven 012, and winding roller 022 with a spool of calendered freestanding-flexible solid-state electrolyte membrane 020 rolled onto, may be positioned. The schematic illustration also shows the general path a fabric support 004, an as coated membrane 010, and a dried freestanding-flexible solid-state electrolyte membrane 014 may take through such a roll-to-roll process.

FIG. 11: A schematic illustration of the roll-to-roll process using gravure printing to print the ceramic-polymer composite solid-state electrolyte slurry 028 onto a fabric support to form a patterned freestanding-flexible solid-state electrolyte membrane 040. FIG. 12: A schematic illustration of the roll-to-roll process using a slurry casting approach to cast the ceramic-polymer composite solid-state electrolyte slurry 048 onto a fabric support to form a freestanding-flexible solid-state electrolyte membrane 052. FIG. 13: A schematic illustration of the roll-to-roll process using a slurry spray approach to spray the ceramic-polymer composite solid-state electrolyte slurry 054 onto a fabric support to form a freestanding-flexible solid-state electrolyte membrane 062. FIG. 14: A schematic illustration of the roll-to-roll process using screen printing to print the ceramic-polymer composite solid-state electrolyte slurry 070 onto a fabric support to form a freestanding-flexible solid-state electrolyte membrane 074.

With reference to the drawings, a roll-to-roll processing method for the fabrication of the freestanding-flexible solid-state electrolyte membrane may include one or more of the following examples.

### EXAMPLE 1

In an example, gravure printing may be used to fabricate a pattered freestanding-flexible solid-state electrolyte membrane 038. In this example, a ceramic-polymer composite slurry 028 may be delivered to in a gravure printing slurry tray 026 via an external feed. An engraved gravure cylinder 032 is partially immersed into said slurry. The engravement on the gravure cylinder 036 is a template for the pattern to be printed. As the gravure cylinder rotates slurry is drawn into the wells of the engravement. A doctor blade 030 is used to remove excess slurry to control film thickness. The gravure cylinder is in contact with a moving fabric support. As gravure cylinder rotates, it prints the slurry onto said fabric support. An impression cylinder 034 located on the opposite of the fabric support and is brought into contact with said fabric support to ensure uniform coating by apply an external pressure. The patterned membrane may roll through the drying oven 012 to form a dried patterned freestanding-flexible solid-state electrolyte membrane 040 and spooled 042. It is assumed that no calendering system or systems would be incorporated into the roll-to-roll process. After printing, the patterned freestanding-flexible solid-state electrolyte membrane may be cut to remove excess bare fabric from said membrane.

Alternatively, gravure printing may be used to fabricate a nonpatterned freestanding-flexible solid-state electrolyte membrane. In this case, the ceramic-polymer composite solid-state electrolyte slurry is drawn onto an nonengraved gravure cylinder surface. A doctor blade is used to remove excess slurry to control film thickness. The gravure cylinder is in contact with a moving fabric support. As gravure cylinder rotates, it prints said slurry onto said fabric support. Once printed, the nonpatterned membrane may be dried and further processed.

### EXAMPLE 2

In another example, doctor blade or slurry casting is used to fabricate a freestanding-flexible solid-state electrolyte membrane. In this example, a ceramic-polymer composite solid-state electrolyte slurry 048 is delivered to the fabric support via a feed 046. The fabric support is continuously moving with no intervals of stoppage. A stationary doctor blade 044 is used to control the coating thickness on the moving fabric support. The casted membrane 050 may be rolled through the drying oven 012 to form a dried freestanding-flexible solid-state electrolyte membrane 052 and spooled 024. Calendering may be done using a calendering system incorporated into the roll-to-roll or by using an external calendering system.

### EXAMPLE 3

In yet another example, spray coating may be used to fabricate a continuous freestanding-flexible solid-state electrolyte membrane. In this example, a ceramic-polymer composite solid-state electrolyte slurry feed 054 is delivered to a spray shower head 056. The slurry is sprayed 058 from the shower head to a continuously moving fabric support. The roll-to-roll process may have one or more shower heads to ensure sufficient coating. The as coated membrane 060 may be rolled through the drying oven 012 to form a dried freestanding-flexible solid-state electrolyte membrane 062 and spooled 024. Calendering may be done using a calendering system incorporated into the roll-to-roll or by using an external calendering system.

Alternatively, spray coating may be used to fabricate a patterned freestanding-flexible solid-state electrolyte membrane. In this instance, the fabric support is continuously in motion while the spraying is intermittent. The shower head or heads are turned on and off to provide the pattern. The rolling speed of the fabric and the duration of the spray coating governs the pattern.

In another alternative, spray coating is intermittent and may be used to fabricate a patterned or continuous freestanding-flexible solid-state electrolyte membrane. In this instance, the fabric support is stationary during spraying and only moves between spray iterations. The distance the fabric support moves may dictate whether or not a patterned or continuous freestanding-flexible solid-state electrolyte membrane is fabricated.

### EXAMPLE 4

In yet another example, screen printing may be used to fabricate the freestanding-flexible solid-state electrolyte membrane. In this example, the fabric support is stationary and only moves between printing iterations. The screen printer 064 is laid on top of the fabric support. A ceramic-polymer composite solid-state electrolyte slurry 068 is delivered through a feed to the screen printer. A squeegee 066 transverses the printing screen and is moved across it pushing said slurry through it on to the fabric support 070. After printing, the screen printer is pulled away from the fabric support. The fabric support is then rolled a discrete distance. Once the fabric support stops, the screen is again positioned about the fabric support, and the printing process repeated. The as coated membrane 072 may be rolled through the drying oven 012 to form a dried freestanding-flexible solid-state electrolyte membrane 074 and spooled 024.

In an aspect, a patterned freestanding-flexible solid-state electrolyte membrane may be fabricated using screen printing. In this instance, the discrete distance the fabric is rolled is larger than the size of the printing screen. Thus, excess bare fabric may be visible between prints.

In another aspect, a continuous freestanding-flexible solid-state electrolyte membrane may be fabricated using screen printing. In this instance, the discrete distance the fabric is rolled is equal to or smaller than the size of the printing screen. Thus, a no excess bare fabric may be visible between prints.

With reference to the drawings, a secondary battery architecture using the freestanding-flexible solid-state electrolyte membrane may include one or more of the following examples.

### EXAMPLE 5

In an example, a solid-state secondary metal battery may be fabricated using the freestanding-flexible solid-state electrolyte membrane 080. In this instance, a metal or metal-alloy 082 is used as the negative electrode 084. Such a battery may include a composite cathode 078 as the positive electrode 076. Protective coatings may be applied to the composite cathode surface or metal/metal-alloy surface to reduce interface resistance with the freestanding-flexible solid-state electrolyte membrane. Such a battery may be fabricated in a pouch, cylindrical, or prismatic type cell.

An example of a solid-state secondary metal battery may include, but not limited to, a lithium metal battery where lithium metal or a lithium metal alloy is the negative electrode. A composite cathode may be comprised of, but not limited to, lithium nickel cobalt oxide as the active material, carbon black as the electrically conductive additive, polyvinylidene fluoride as the binder, and garnet-structure lithium lanthanum zirconium oxide as the ionic-conductive additive. A flexible solid-state electrolyte membrane may include, but not limited to, metal-mesh-based fabric coated with a thin transition metal oxide layer as the electronic insulator layer and lithium lanthanum zirconium oxide/polyvinylidene fluoride composite as the ionic conductive mixture.

### EXAMPLE 6

In another example, a semi-solid-state secondary metal battery may be fabricated using the freestanding-flexible solid-state electrolyte membrane 080. In this instance, a metal or metal-alloy 082 is used as the negative electrode 084. Such a battery may include a cathode 086 or composite cathode 078 as the positive electrode 076. A liquid-based electrolyte 088 is used reduce interface resistance with the freestanding-flexible solid-state electrolyte membrane. A liquid-based electrolyte may include, but not limited to, organic-based or a room temperature ionic liquid electrolyte. Such a battery may be fabricated in a pouch, cylindrical, or prismatic type cell.

An example of a semi-solid-state secondary metal battery may include, but not limited to, a hybrid lithium metal battery where lithium metal or a lithium metal alloy is the negative electrode and a mixture of ethylene carbonate and dimethyl carbonate (1:1), with one molar of lithium hexafluorophosphate as the ionic conductive salt, is the liquid electrolyte. A cathode may include, but not limited to, lithium iron phosphate as the active material, carbon black as the electrically conductive additive, polyvinylidene fluoride as the binder. A flexible solid-state electrolyte membrane may include, but not limited to, a textile-based fabric coated with a polyvinylidene fluoride and lithium lanthanum zirconium oxide composite as the ionic conductive mixture.

### EXAMPLE 7

In yet another example, a solid-state secondary battery may be fabricated using the freestanding-flexible solid-state electrolyte membrane 080. In this instance, a composite anode 090 is used as the negative electrode 084. Such a battery may include a composite cathode 086 as the positive electrode 076. Protective coatings may be applied to the composite cathode surface and or composite anode surface to reduce interface resistance with the freestanding-flexible solid-state electrolyte membrane. Such a battery may be fabricated in a pouch, cylindrical, or prismatic type cell.

An example of a solid-state secondary battery may include, but not limited to, a solid-state lithium battery where composite-based electrodes are used. The composite anode may include, but not limited to, graphite as the active material, carbon black as the electrically conductive additive, styrene-butadiene rubber as the binder, and argyrodite as the ionic-conductive additive. The composite cathode may include, but not limited to, lithium cobalt oxide as the active material, carbon black as the electrically conductive additive, styrene-butadiene rubber as the binder, and argyrodite as the ionic-conductive additive. A flexible solid-state electrolyte membrane may include, but not limited to, metal-mesh-based fabric coated with a thin polymer layer as the electronic insulator layer and argyrodite/styrene-butadiene rubber composite as the ionic conductive mixture.

### EXAMPLE 8

In yet another example, a semi-solid-state secondary battery may be fabricated using the freestanding-flexible solid-state electrolyte membrane 080. In this instance, an anode 092 or composite anode 090 is used as the negative electrode 084. Such a battery may include a cathode 086 or composite cathode 078. A liquid-based electrolyte 088 is used reduce interface resistance with the freestanding-flexible solid-state electrolyte membrane. A liquid-based electrolyte may include, but not limited to, organic-based or a room temperature ionic liquid electrolyte. Such a battery may be fabricated in a pouch, cylindrical, or prismatic type cell.

An example of a semi-solid-state secondary battery may include, but not limited to, a hybrid lithium battery where a composite anode is the negative electrode, a cathode is the positive electrode, and a mixture of ethylene carbonate and dimethyl carbonate (1:1), with one molar of lithium hexafluorophosphate as the ionic conductive salt, is the liquid electrolyte. A composite anode may include, but not limited to, graphite as the active material, carbon black as the electrically conductive additive, polyvinylidene fluoride as the binder, and NASICON-type LAGP as the ionic conductor. A cathode may include, but not limited to, lithium iron phosphate as the active material, carbon black as the electrically conductive additive, polyvinylidene fluoride as the binder. A flexible solid-state electrolyte membrane may include, but not limited to, textile-based fabric coated with NASICON-type LAGP/polyvinylidene fluoride composite as the ionic conductive mixture.

The above described systems and methods can be ascribed to lithium-based secondary batteries such as, but not limited to, lithium-ion batteries, lithium metal batteries, all-solid-state lithium batteries, aqueous batteries, lithium polymer batteries, etc. The above described systems and methods can be ascribed to various secondary battery designs such as, but not limited to, pouch cell, coil cell, button cell, cylindrical cell, prismatic cell, etc. The above described systems and methods can be ascribed to secondary batteries with the end use applications such as, but not limited to, electric vehicles, hybrid electric vehicles, mobile devices, handheld electronics, consumer electronics, medical, medical wearables, and wearables for portable energy storage. The above described systems and methods can be ascribed to secondary batteries for grid scale energy storage backup systems. The above described systems and methods can be ascribed to secondary batteries for longevity, higher energy density and power density and improved safety. The above described systems and methods can be ascribed for alternative energy storage technologies such as redox flow batteries, capacitors, supercapacitors, and fuel cells. The above described systems and methods can be ascribed for upstream and downstream metal industries. Upstream industries may include mining or extraction. Downstream industries may include the recycling of spent secondary batteries. The above described systems and methods can be ascribed for upstream and downstream lithium industries. Upstream industries may include lithium mining or extraction. Downstream industries may include the recycling of spent secondary lithium batteries.

### LIST OF REFERENCE NUMBERS

000—Unwinding roller; 002—Fabric spool; 004—Fabric support; 006—Tension rollers; 007—Guide rollers; 008—Location of general casting/coating/printing equipment; 010—As coated freestanding-flexible solid-state electrolyte membrane; 012—Oven/dryer; 014—Dried coated freestanding-flexible solid-state electrolyte membrane; 016—Calendering rollers; 018—Calendered coated freestanding-flexible solid-state electrolyte membrane; 020—Spool of calendered freestanding-flexible solid-state electrolyte membrane; 022—Winding roller; 024—Spool of uncalendered freestanding-flexible solid-state electrolyte membrane; 026—Slurry tray for gravure printer; 028—Ceramic-polymer composite slurry for gravure printing; 030—Doctor blade for gravure printer; 032—Engraved gravure cylinder; 034—Impression cylinder; 036—Engravement on gravure cylinder; 038—As printed patterned freestanding-flexible solid-state electrolyte membrane; 040—Dried patterned freestanding-flexible solid-state electrolyte membrane; 042—Spool of pattered freestanding-flexible solid-state electrolyte membrane; 044—Doctor blade for slurry casting; 046—Slurry feed for slurry casting; 048—Ceramic-polymer composite electrolyte slurry for slurry casting; 050—As casted freestanding-flexible solid-state electrolyte membrane; 052—Dried slurry casted freestanding-flexible solid-state electrolyte membrane; 054—Slurry feed for spray coating; 056—Shower head for spray coating; 058—Sprayed slurry plume; 060—As sprayed freestanding-flexible solid-state electrolyte membrane; 062—Dried spray coated freestanding-flexible solid-state electrolyte membrane; 064—Screen printer; 066—Screen printing squeegee; 068—Ceramic-polymer composite slurry for screen printing; 070—The in-progress screen printed freestanding-flexible solid-state electrolyte membrane; 072—As printed freestanding-flexible solid-state electrolyte membrane; 074—Dried screen-printed freestanding-flexible solid-state electrolyte membrane; 076—Positive electrode current collector; 078—Composite cathode; 080—Freestanding-flexible solid-state electrolyte membrane; 082—Metal/metal-alloy anode; 084—Negative electrode current collector; 086—Cathode; 088—Organic-based liquid/room temperature ionic liquid electrolyte; 090—Composite anode; 092—Anode; 094—Fabric support; 096—Solvent+Polymer+Ionic Conducting salt; 098—Ionic Conductive Ceramic; 100—Polymer+Ionic Conductive Salt.

Although various embodiments of the disclosed solid-state electrolyte membranes, secondary batteries comprising solid-state electrolyte membranes, and methods for manufacturing solid-state electrolyte membranes have been shown and described, modifications may occur to those skilled in the art upon reading the specification. The present disclosure includes such modifications and is limited only by the scope of the claims.

Various aspects are represented below by the following clauses. The present invention is not limited to the aspects represented in these clauses. Rather, the present invention includes these aspects in combination with any one or more additional features described above or illustrated in the encloses drawings.

Clause 1. A solid-state electrolyte membrane, comprising: a fabric support; and a ceramic-polymer composite solid-state electrolyte on the fabric support.

Clause 2. The solid-state electrolyte membrane of clause 1, wherein the fabric support is electrically insulating.

Clause 3. The solid-state electrolyte membrane of clause 1, wherein the fabric support is electrically conductive.

Clause 4. The solid-state electrolyte membrane of clause 1, wherein the fabric support is electrically conductive with an electrically insulative coating.

Clause 5. The solid-state electrolyte membrane of any one of the preceding clauses, wherein the fabric support is ionic conductive.

Clause 6. The solid-state electrolyte membrane of any one of clauses 1 to 4, wherein the fabric support is nonionic conductive.

Clause 7. The solid-state electrolyte membrane of any one of the preceding clauses, wherein the fabric support comprises fibers.

Clause 8. The solid-state electrolyte membrane of clause 7, wherein the fabric support comprises natural fibers.

Clause 9. The solid-state electrolyte membrane of clause 8, wherein the fabric support comprises plant fibers.

Clause 10. The solid-state electrolyte membrane of any one of clauses 8 to 9, wherein the fabric support comprises bast fibers.

Clause 11. The solid-state electrolyte membrane of any one of clauses 8 to 10, wherein the fabric support comprises leaf fibers.

Clause 12. The solid-state electrolyte membrane of any one of clauses 8 to 11, wherein the fabric support comprises husk fibers.

Clause 13. The solid-state electrolyte membrane of any one of clauses 8 to 12, wherein the fabric support comprises animal fibers.

Clause 14. The solid-state electrolyte membrane of any one of clauses 8 to 13, wherein the fabric support comprises at least one of cotton, stem, flux, hemp, sisal, coconut, wool, silk, cashmere, chitin, chitosan, collagen, keratin, furs, and combinations thereof.

Clause 15. The solid-state electrolyte membrane of any one of clauses 7 to 14, wherein the fabric support comprises synthetic fibers.

Clause 16. The solid-state electrolyte membrane of clause 15, wherein the fabric support comprises at least one of polyesters, polyimides (PI), polyolefins, polyvinyl chloride (PVC), polyvinylidene chloride (PVDC), poly(methyl methacrylate) (PMMA), polyvinylidene fluoride (PVDF), polyether-polyurea copolymer, polyvinyl alcohol (PVA), polybenzimidazole, polyacrylonitrile (PAN), polyphenylene sulfide (PPS), poly(lactic acid), polyhydroquinone-diimidazopyridine, polyparaphenylene benzobisthiazole (PBT), polyparaphenylene benzobisimidazole (PBI), polyethylene terephthalate (PET), polyparaphenylenebenzobisoxazole (PBO), poly(p-phenylene-2,6-benzobisoxazole), Kevlar, 6-nylon, 66-nylon, acrylic fibers, cellulose fibers, polyethylene naphthalate, polyether ether ketone, modified polyphenylene ether (PPE), glass fiber, fiberglass, liquid crystal polymer and combinations thereof.

Clause 17. The solid-state electrolyte membrane of any one of clauses 7 to 16, wherein the fabric support comprises a textile-based fabric.

Clause 18. The solid-state electrolyte membrane of any one of clauses 7 to 17, wherein the fabric support is non-woven.

Clause 19. The solid-state electrolyte membrane of any one of clauses 7 to 18, wherein the fabric support comprises at least one of satin, denim, crepel, fleece, polyester, linen, velvet, damas, cheesecloth, chiffon, rayon, baize, batiste, chameuse, chenille, cheviot, felt, twill, velvet, jersey, lace, lycra, polycotton, and combinations thereof.

Clause 20. The solid-state electrolyte membrane of any one of clauses 7 to 19, wherein the fabric support comprises a textile-based fabric fabricated from at least one of weaving, knitting, crocheting, knotting, tatting, felting, braiding, electrospinning, and electrospraying.

Clause 21. The solid-state electrolyte membrane of any one of the preceding clauses, wherein the fabric support comprises metal.

Clause 22. The solid-state electrolyte membrane of clause 21, wherein the fabric support comprises at least one of copper, aluminum, stainless steel, nickel, titanium, vanadium, iron, cobalt, zinc, molybdenum, niobium, and combinations thereof.

Clause 23. The solid-state electrolyte membrane of any one of clauses 20 to 21, wherein the fabric support comprises a metal-mesh-based fabric.

Clause 24. The solid-state electrolyte membrane of clause 23, wherein the metal-mesh-based fabric comprises at least one of copper, aluminum, stainless steel, nickel, titanium, vanadium, iron, cobalt, zinc, molybdenum, niobium, and combinations thereof.

Clause 25. The solid-state electrolyte membrane of any one of clauses 23 to 24, wherein the fabric support comprises an electrically insulating layer on the metal-mesh-based fabric.

Clause 26. The solid-state electrolyte membrane of clause 25, wherein the electrically insulating layer comprises at least one of a polymer, a metal oxide, a ceramic, and combinations thereof.

Clause 27. The solid-state electrolyte membrane of any one of clauses 25 to 26, wherein the electrically insulating layer has a thickness ranging from 1<t<1000 nm.

Clause 28. The solid-state electrolyte membrane of any one of clauses 25 to 26, wherein the electrically insulating layer has a thickness ranging from 5<t<100 nm.

Clause 29. The solid-state electrolyte membrane of clause 1, wherein the fabric support is an open cell structure.

Clause 30. The solid-state electrolyte membrane of any one the preceding clauses, wherein the fabric support has a thickness ranging from 0.01<t<1000 μm.

Clause 31. The solid-state electrolyte membrane of any one of clauses 1 to 29, wherein the fabric support has a thickness ranging from 0.1<t<500 μm.

Clause 32. The solid-state electrolyte membrane of any one the preceding clauses, wherein the ceramic-polymer composite solid-state electrolyte comprises a polymer.

Clause 33. The solid-state electrolyte membrane of any one the preceding clauses, wherein the ceramic-polymer composite solid-state electrolyte comprises an ionic conductive polymer.

Clause 34. The solid-state electrolyte membrane of any one the preceding clauses, wherein the ceramic-polymer composite solid-state electrolyte comprises an nonionic conductive polymer.

Clause 35. The solid-state electrolyte membrane of any one the preceding clauses, wherein the ceramic-polymer composite solid-state electrolyte comprises at least one of polyethylene glycol, polyisobutene, polyvinylidene fluoride, and polyvinyl alcohol.

Clause 36. The solid-state electrolyte membrane of any one the preceding clauses, wherein the ceramic-polymer composite solid-state electrolyte comprises a polyolefin.

Clause 37. The solid-state electrolyte membrane of any one the preceding clauses, wherein the ceramic-polymer composite solid-state electrolyte comprises polyethylene, poly(butene-1), poly(n-pentene-2), polypropylene, or polytetrafluoroethylene.

Clause 38. The solid-state electrolyte membrane of any one the preceding clauses, wherein the ceramic-polymer composite solid-state electrolyte comprises a polyamine.

Clause 39. The solid-state electrolyte membrane of any one the preceding clauses, wherein the ceramic-polymer composite solid-state electrolyte comprises poly(ethylene imine) or polypropylene imine (PPI).

Clause 40. The solid-state electrolyte membrane of any one the preceding clauses, wherein the ceramic-polymer composite solid-state electrolyte comprises a polyamide.

Clause 41. The solid-state electrolyte membrane of any one the preceding clauses, wherein the ceramic-polymer composite solid-state electrolyte comprises polyamide (Nylon), poly(ε-caprolactam) (Nylon 6), or poly(hexamethylene adipamide) (Nylon 66).

Clause 42. The solid-state electrolyte membrane of any one the preceding clauses, wherein the ceramic-polymer composite solid-state electrolyte comprises a polyimide.

Clause 43. The solid-state electrolyte membrane of any one the preceding clauses, wherein the ceramic-polymer composite solid-state electrolyte comprises polyimide, polynitrile, and poly(pyromellitimide-1,4-diphenyl ether) Kapton, Nomex, or Kevlar.

Clause 44. The solid-state electrolyte membrane of any one the preceding clauses, wherein the ceramic-polymer composite solid-state electrolyte comprises polyether ether ketone (PEEK).

Clause 45. The solid-state electrolyte membrane of any one the preceding clauses, wherein the ceramic-polymer composite solid-state electrolyte comprises a vinyl polymer.

Clause 46. The solid-state electrolyte membrane of any one the preceding clauses, wherein the ceramic-polymer composite solid-state electrolyte comprises polyacrylamide, poly(-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(-vinyl pyridine), vinyl polymer, polychlorotrifluoro ethylene, or poly(isohexylcynaoacrylate).

Clause 47. The solid-state electrolyte membrane of any one the preceding clauses, wherein the ceramic-polymer composite solid-state electrolyte comprises a polyacetal.

Clause 48. The solid-state electrolyte membrane of any one the preceding clauses, wherein the ceramic-polymer composite solid-state electrolyte comprises a polyester.

Clause 49. The solid-state electrolyte membrane of any one the preceding clauses, wherein the ceramic-polymer composite solid-state electrolyte comprises polycarbonate, polybutylene terephthalate, or polyhydroxybutyrate.

Clause 50. The solid-state electrolyte membrane of any one the preceding clauses, wherein the ceramic-polymer composite solid-state electrolyte comprises a polyether.

Clause 51. The solid-state electrolyte membrane of any one the preceding clauses, wherein the ceramic-polymer composite solid-state electrolyte comprises poly(ethylene oxide) (PEO), poly(propylene oxide) (PPO), or poly(tetramethylene oxide) (PTMO).

Clause 52. The solid-state electrolyte membrane of any one the preceding clauses, wherein the ceramic-polymer composite solid-state electrolyte comprises a vinylidene polymer.

Clause 53. The solid-state electrolyte membrane of any one the preceding clauses, wherein the ceramic-polymer composite solid-state electrolyte comprises polyisobutylene, poly(methyl styrene), poly(methylmethacrylate) (PMMA), poly(vinylidene chloride), or poly(vinylidene fluoride).

Clause 54. The solid-state electrolyte membrane of any one the preceding clauses, wherein the ceramic-polymer composite solid-state electrolyte comprises a polyaramide.

Clause 55. The solid-state electrolyte membrane of any one the preceding clauses, wherein the ceramic-polymer composite solid-state electrolyte comprises poly(imino-1,3-phenylene iminoisophthaloyl) or poly(imino-1,4-phenylene iminoterephthaloyl).

Clause 56. The solid-state electrolyte membrane of any one the preceding clauses, wherein the ceramic-polymer composite solid-state electrolyte comprises a polyheteroaromatic compound.

Clause 57. The solid-state electrolyte membrane of any one the preceding clauses, wherein the ceramic-polymer composite solid-state electrolyte comprises polybenzimidazole (PBI), polybenzobisoxazole (PBT) or polybenzobisthiazole (PBT).

Clause 58. The solid-state electrolyte membrane of any one the preceding clauses, wherein the ceramic-polymer composite solid-state electrolyte comprises a polyheterocyclic compound.

Clause 59. The solid-state electrolyte membrane of any one the preceding clauses, wherein the ceramic-polymer composite solid-state electrolyte comprises polypyrrole.

Clause 60. The solid-state electrolyte membrane of any one the preceding clauses, wherein the ceramic-polymer composite solid-state electrolyte comprises a polyurethane.

Clause 61. The solid-state electrolyte membrane of any one the preceding clauses, wherein the ceramic-polymer composite solid-state electrolyte comprises a phenolic polymer.

Clause 62. The solid-state electrolyte membrane of any one the preceding clauses, wherein the ceramic-polymer composite solid-state electrolyte comprises phenol-formaldehyde.

Clause 63. The solid-state electrolyte membrane of any one the preceding clauses, wherein the ceramic-polymer composite solid-state electrolyte comprises a polyalkyne.

Clause 64. The solid-state electrolyte membrane of any one the preceding clauses, wherein the ceramic-polymer composite solid-state electrolyte comprises polyacetylene.

Clause 65. The solid-state electrolyte membrane of any one the preceding clauses, wherein the ceramic-polymer composite solid-state electrolyte comprises a polydiene.

Clause 66. The solid-state electrolyte membrane of any one the preceding clauses, wherein the ceramic-polymer composite solid-state electrolyte comprises 1,2-polybutadiene, cis-1,4-polybutadiene or trans-1,4-polybutadiene.

Clause 67. The solid-state electrolyte membrane of any one the preceding clauses, wherein the ceramic-polymer composite solid-state electrolyte comprises a polysiloxane.

Clause 68. The solid-state electrolyte membrane of any one the preceding clauses, wherein the ceramic-polymer composite solid-state electrolyte comprises poly(dimethylsiloxane) (PDMS), poly(diethylsiloxane) (PDES), polydiphenylsiloxane (PDPS), or polymethylphenylsiloxane (PMPS).

Clause 69. The solid-state electrolyte membrane of any one the preceding clauses, wherein the ceramic-polymer composite solid-state electrolyte comprises an inorganic polymer.

Clause 70. The solid-state electrolyte membrane of any one the preceding clauses, wherein the ceramic-polymer composite solid-state electrolyte comprises polyphosphazene.

Clause 71. The solid-state electrolyte membrane of any one the preceding clauses, wherein the ceramic-polymer composite solid-state electrolyte comprises a polyphosphonate.

Clause 72. The solid-state electrolyte membrane of any one the preceding clauses, wherein the ceramic-polymer composite solid-state electrolyte comprises a polysilane.

Clause 73. The solid-state electrolyte membrane of any one the preceding clauses, wherein the ceramic-polymer composite solid-state electrolyte comprises a polysilazane.

Clause 74. The solid-state electrolyte membrane of any one the preceding clauses, wherein the ceramic-polymer composite solid-state electrolyte comprises an ionic conductive salt.

Clause 75. The solid-state electrolyte membrane of any one the preceding clauses, wherein the ceramic-polymer composite solid-state electrolyte comprises a lithium ionic conductive salt.

Clause 76. The solid-state electrolyte membrane of any one the preceding clauses, wherein the ceramic-polymer composite solid-state electrolyte comprises lithium bis(trifluoromethanesulfonyl)imide (LiTFSI), lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), or LiNO₃.

Clause 77. The solid-state electrolyte membrane of any one the preceding clauses, wherein the ceramic-polymer composite solid-state electrolyte comprises a sodium ionic conductive salt.

Clause 78. The solid-state electrolyte membrane of any one the preceding clauses, wherein the ceramic-polymer composite solid-state electrolyte comprises sodium bis(trifluoromethanesulfonyl)imide (NaTFSI), sodium bis(fluorosulfonyl)imide (NaFSI), sodium bis(oxalato)borate (NaBOB), Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, or NaNO₃,

Clause 79. The solid-state electrolyte membrane of any one the preceding clauses, wherein the ceramic-polymer composite solid-state electrolyte comprises a magnesium ionic conductive salt.

Clause 80. The solid-state electrolyte membrane of any one the preceding clauses, wherein the ceramic-polymer composite solid-state electrolyte comprises magnesium bis(trifluoromethanesulfonyl)imide (Mg(TFSI)₂), magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, or Mg(CH₃COOH)₂.

Clause 81. The solid-state electrolyte membrane of any one the preceding clauses, wherein the ceramic-polymer composite solid-state electrolyte comprises a potassium ionic conductive salt.

Clause 82. The solid-state electrolyte membrane of any one the preceding clauses, wherein the ceramic-polymer composite solid-state electrolyte comprises potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), or KNO₃.

Clause 83. The solid-state electrolyte membrane of any one the preceding clauses, wherein the ceramic-polymer composite solid-state electrolyte comprises an aluminum ionic conductive salt.

Clause 84. The solid-state electrolyte membrane of any one the preceding clauses, wherein the ceramic-polymer composite solid-state electrolyte comprises Al(NO₃)₂, AlCl₃, Al₂(SO₄)₃, AlBr₃, AlI₃, AlN, AlSCN, or Al(ClO₄)₃.

Clause 85. The solid-state electrolyte membrane of any one the preceding clauses, wherein the ceramic-polymer composite solid-state electrolyte comprises an ionic conductive ceramic.

Clause 86. The solid-state electrolyte membrane of any one the preceding clauses, wherein the ceramic-polymer composite solid-state electrolyte comprises an ionic conductive ceramic that is ionic conductive to H⁺, Na⁺, K⁺, Ag⁺, Mg²⁺, Al³⁺, Zn²⁺, and combinations thereof.

Clause 87. The solid-state electrolyte membrane of any one the preceding clauses, wherein the ceramic-polymer composite solid-state electrolyte comprises a garnet-like structure oxide material.

Clause 88. The solid-state electrolyte membrane of any one the preceding clauses, wherein the ceramic-polymer composite solid-state electrolyte comprises a garnet-like structure oxide material with the general formula:

Liₙ[A(_{3-a′-a″)}A′(_{a′})A″(_{a″})][B(_{2-b′-b″})B′(_{b′})B″(_{b″})][C′(_{c′})C″(_{c″})]O₁₂,

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;

b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;

c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and

d. wherein n=7+a′+2·a″−b′−2·b″−3·c′−4·c″ and 4.5≤n≤7.5.

Clause 89. The solid-state electrolyte membrane of any one the preceding clauses, wherein the ceramic-polymer composite solid-state electrolyte comprises a perovskite-type oxide.

Clause 90. The solid-state electrolyte membrane of any one the preceding clauses, wherein the ceramic-polymer composite solid-state electrolyte comprises (Li,La)TiO₃ or (Li,La)TiO₃ with doped or replaced compounds.

Clause 91. The solid-state electrolyte membrane of any one the preceding clauses, wherein the ceramic-polymer composite solid-state electrolyte comprises NASICON-structured lithium membrane.

Clause 92. The solid-state electrolyte membrane of any one the preceding clauses, wherein the ceramic-polymer composite solid-state electrolyte comprises LAGP (Li₁-xAlₓGe₂₋ₓ(PO₄)₃).

Clause 93. The solid-state electrolyte membrane of any one the preceding clauses, wherein the ceramic-polymer composite solid-state electrolyte comprises LAGP (Li₁-xAlₓGe₂₋ₓ(PO₄)₃) with other elements doped therein.

Clause 94. The solid-state electrolyte membrane of any one the preceding clauses, wherein the ceramic-polymer composite solid-state electrolyte comprises LATP (Li₁+xAlₓTi₂₋ₓ(PO₄)₃).

Clause 95. The solid-state electrolyte membrane of any one the preceding clauses, wherein the ceramic-polymer composite solid-state electrolyte comprises LATP (Li₁+xAlₓTi₂₋ₓ(PO₄)₃) with other elements doped therein.

Clause 96. The solid-state electrolyte membrane of any one the preceding clauses, wherein the ceramic-polymer composite solid-state electrolyte comprises an anti-perovskite structure material or derivative thereof.

Clause 97. The solid-state electrolyte membrane of any one the preceding clauses, wherein the ceramic-polymer composite solid-state electrolyte comprises a Li₃OCl, Li₃OBr, or Li₃OI.

Clause 98. The solid-state electrolyte membrane of any one the preceding clauses, wherein the ceramic-polymer composite solid-state electrolyte comprises a material from the Li₃YH₆(H═F, Cl, Br, I) family of materials, wherein Y can be replaced by other rare earth elements.

Clause 99. The solid-state electrolyte membrane of any one the preceding clauses, wherein the ceramic-polymer composite solid-state electrolyte comprises Li₂ₓS_{x+w+5z}M_{y}P_{2z}, wherein x is 8-16, y is 0.1-6, w is 0.1-15, z is 0.1-3, and wherein M is selected from the group consisting of lanthanides, Group 3, Group 4, Group 5, Group 6, Group 7, Group 8, Group 9, Group 12, Group 13, and Group 14 atoms, and combinations thereof.

Clause 100. The solid-state electrolyte membrane of any one the preceding clauses, wherein the ceramic-polymer composite solid-state electrolyte comprises an argyrodites material.

Clause 101. The solid-state electrolyte membrane of any one the preceding clauses, wherein the ceramic-polymer composite solid-state electrolyte comprises an argyrodites material with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻═O²⁻, S²⁻, Se²⁻, Te²⁻, or a combination thereof; X⁻═F⁻, Cl⁻, Br⁻, I⁻, or a combination thereof; and x is in the range of 0≤x≤2.

Clause 102. The solid-state electrolyte membrane of any one the preceding clauses, wherein the ceramic-polymer composite solid-state electrolyte comprises an ionic conductive ceramic in a range of from greater than 0% to less than 100% by mass of the total mass of the ceramic-polymer composite solid-state electrolyte.

Clause 103. The solid-state electrolyte membrane of any one the preceding clauses, wherein the ceramic-polymer composite solid-state electrolyte comprises an ionic conductive ceramic in a range of from 80% to 99.99% by mass of the total mass of the ceramic-polymer composite solid-state electrolyte.

Clause 104. The solid-state electrolyte membrane of any one the preceding clauses, wherein the ceramic-polymer composite solid-state electrolyte comprises an ionic conductive ceramic in a range of from 90% to 99.9% by mass of the total mass of the ceramic-polymer composite solid-state electrolyte.

Clause 105. The solid-state electrolyte membrane of any one the preceding clauses, wherein the ceramic-polymer composite solid-state electrolyte comprises an ionic conductive ceramic in a range of from 95% to 99.5% by mass of the total mass of the ceramic-polymer composite solid-state electrolyte.

Clause 106. The solid-state electrolyte membrane of any one the preceding clauses, wherein the ceramic-polymer composite solid-state electrolyte comprises ionic conductive ceramic particles, wherein the ionic conductive ceramic particles have a particle size in the range of 0.001<d<100 μm.

Clause 107. The solid-state electrolyte membrane of any one the preceding clauses, wherein the ceramic-polymer composite solid-state electrolyte comprises ionic conductive ceramic particles, wherein the ionic conductive ceramic particles have a particle size in the range of 0.1<d<10 μm.

Clause 108. The solid-state electrolyte membrane of any one the preceding clauses, wherein the ceramic-polymer composite solid-state electrolyte comprises ionic conductive ceramic particles, wherein the ionic conductive ceramic particles have a morphology including one or more of nanoparticles, cubes, nanocubes, fibers, nanofibers, wires, nanowires, quantum dots, nanotubes, and octahedrons.

Clause 109. The solid-state electrolyte membrane of any one the preceding clauses, wherein the ceramic-polymer composite solid-state electrolyte includes a porosity of less than 20% by total volume of the ceramic-polymer composite solid-state electrolyte.

Clause 110. The solid-state electrolyte membrane of any one the preceding clauses, wherein the ceramic-polymer composite solid-state electrolyte includes a porosity of less than 18% by total volume of the ceramic-polymer composite solid-state electrolyte.

Clause 111. The solid-state electrolyte membrane of any one the preceding clauses, wherein the ceramic-polymer composite solid-state electrolyte includes a porosity of less than 16% by total volume of the ceramic-polymer composite solid-state electrolyte.

Clause 112. The solid-state electrolyte membrane of any one the preceding clauses, wherein the ceramic-polymer composite solid-state electrolyte includes a porosity of less than 14% by total volume of the ceramic-polymer composite solid-state electrolyte.

Clause 113. The solid-state electrolyte membrane of any one the preceding clauses, wherein the ceramic-polymer composite solid-state electrolyte includes a porosity of less than 12% by total volume of the ceramic-polymer composite solid-state electrolyte.

Clause 114. The solid-state electrolyte membrane of any one the preceding clauses, wherein the ceramic-polymer composite solid-state electrolyte includes a porosity of less than 10% by total volume of the ceramic-polymer composite solid-state electrolyte.

Clause 115. The solid-state electrolyte membrane of any one the preceding clauses, wherein the ceramic-polymer composite solid-state electrolyte includes a porosity of less than 8% by total volume of the ceramic-polymer composite solid-state electrolyte.

Clause 116. The solid-state electrolyte membrane of any one the preceding clauses, wherein the ceramic-polymer composite solid-state electrolyte includes a porosity of less than 6% by total volume of the ceramic-polymer composite solid-state electrolyte.

Clause 117. The solid-state electrolyte membrane of any one the preceding clauses, wherein the ceramic-polymer composite solid-state electrolyte includes an ionic conductive ceramic, wherein the ionic conductive ceramic is present in a range of from greater than 0% to less than 100% by volume of the total volume of the ceramic-polymer composite solid-state electrolyte.

Clause 118. The solid-state electrolyte membrane of any one the preceding clauses, wherein the ceramic-polymer composite solid-state electrolyte includes an ionic conductive ceramic, wherein the ionic conductive ceramic is present in a range of from 50% to 99.99% by volume of the total volume of the ceramic-polymer composite solid-state electrolyte.

Clause 119. The solid-state electrolyte membrane of any one the preceding clauses, wherein the ceramic-polymer composite solid-state electrolyte includes an ionic conductive ceramic, wherein the ionic conductive ceramic is present in a range of from 60% to 99.95% by volume of the total volume of the ceramic-polymer composite solid-state electrolyte.

Clause 120. The solid-state electrolyte membrane of any one the preceding clauses, wherein the ceramic-polymer composite solid-state electrolyte includes an ionic conductive ceramic, wherein the ionic conductive ceramic is present in a range of from 70% to 99.9% by volume of the total volume of the ceramic-polymer composite solid-state electrolyte.

Clause 121. The solid-state electrolyte membrane of any one the preceding clauses, wherein the ceramic-polymer composite solid-state electrolyte includes an ionic conductive ceramic, wherein the ionic conductive ceramic is present in a range of from 80% to 99.5% by volume of the total volume of the ceramic-polymer composite solid-state electrolyte.

Clause 122. The solid-state electrolyte membrane of any one the preceding clauses, wherein the ceramic-polymer composite solid-state electrolyte includes an ionic conductive ceramic, wherein the ionic conductive ceramic is present in a range of from 85% to 99% by volume of the total volume of the ceramic-polymer composite solid-state electrolyte.

Clause 123. The solid-state electrolyte membrane of any one the preceding clauses having a thickness in a range of 1<t<1000 μm.

Clause 124. The solid-state electrolyte membrane of any one the preceding clauses having a thickness in a range of 10<t<100 μm.

Clause 125. The solid-state electrolyte membrane of any one the preceding clauses, wherein a ratio of a thickness of the solid-state electrolyte membrane to a thickness of the fabric support is in a range of from greater than 1 to 5.

Clause 126. The solid-state electrolyte membrane of any one the preceding clauses, wherein a ratio of a thickness of the solid-state electrolyte membrane to a thickness of the fabric support is in a range of from greater than 1 to 2.

Clause 127. The solid-state electrolyte membrane of any one the preceding clauses, wherein a ratio of a thickness of the solid-state electrolyte membrane to a thickness of the fabric support is in a range of from greater than 1 to 1.5.

Clause 128. The solid-state electrolyte membrane of any one the preceding clauses, wherein a ratio of a thickness of the solid-state electrolyte membrane to a thickness of the fabric support is in a range of from greater than 1 to 1.2.

Clause 129. The solid-state electrolyte membrane of any one the preceding clauses, wherein the ceramic-polymer composite solid-state electrolyte further comprises a nonionic conducting additive.

Clause 130. The solid-state electrolyte membrane of any one the preceding clauses, wherein the ceramic-polymer composite solid-state electrolyte further comprises alumina, titanium, lanthanum oxide, or zirconia.

Clause 131. The solid-state electrolyte membrane of any one the preceding clauses, wherein the ceramic-polymer composite solid-state electrolyte further comprises an epoxy.

Clause 132. The solid-state electrolyte membrane of any one the preceding clauses, wherein the ceramic-polymer composite solid-state electrolyte further comprises a resin.

Clause 133. The solid-state electrolyte membrane of any one the preceding clauses, wherein the ceramic-polymer composite solid-state electrolyte further comprises a plasticizer.

Clause 134. The solid-state electrolyte membrane of any one the preceding clauses, wherein the ceramic-polymer composite solid-state electrolyte further comprises a surfactant.

Clause 135. The solid-state electrolyte membrane of any one the preceding clauses, wherein the ceramic-polymer composite solid-state electrolyte further comprises a binder.

Clause 136. The solid-state electrolyte membrane of any one the preceding clauses, wherein the ceramic-polymer composite solid-state electrolyte further comprises an ionic conducting additive.

Clause 137. The solid-state electrolyte membrane of any one the preceding clauses, wherein the ceramic-polymer composite solid-state electrolyte further comprises ethylene carbonate (EC), dimethyl carbonate (DMC), and diethyl carbonate (DEC), propylene carbonate (PC), tetraethylene glycol dimethyl ether (TEGDME), fluoroethylene carbonate (FEC), vinylene carbonate (VC), or vinyl ethylene carbonate (VEC).

Clause 138. The solid-state electrolyte membrane of any one the preceding clauses having a room temperature ionic conductivity of ≥0.1 mS cm⁻¹.

Clause 1. A secondary battery, comprising: a cathode, an anode, and the solid-state electrolyte membrane of any one of the preceding clauses between the cathode and the anode, the solid-state electrolyte membrane comprising a fabric support and a ceramic-polymer composite solid-state electrolyte on the fabric support.

Clause 2. The secondary battery of clause 1, wherein the secondary battery is in the form of an ion-based battery.

Clause 3. The secondary battery of clause 1, wherein the secondary battery is in the form of a metal battery.

Clause 4. The secondary battery of clause 1, wherein the secondary battery is in the shape of a pouch cell.

Clause 5. The secondary battery of clause 1, wherein the secondary battery is in the shape of a cylindrical cell.

Clause 6. The secondary battery of clause 1, wherein the secondary battery is in the shape of a prismatic cell.

Clause 7. The secondary battery of any one of the preceding clauses, wherein the secondary battery is a lithium ion battery, a sodium ion battery, a magnesium ion battery, an aluminum ion battery, a potassium ion battery, a zinc ion battery, a lithium metal battery, a sodium metal battery, a magnesium metal battery, an aluminum metal battery, a potassium metal battery, a zinc metal battery, a nickel cadmium battery, a nickel-metal hydride battery, a glass battery, a lithium-ion polymer battery, a lithium-sulfur battery, a sodium sulfide battery, a zinc-bromide battery, or a lithium titanate battery.

Clause 8. The secondary battery of any one of the preceding clauses, wherein the cathode comprises a composite cathode.

Clause 9. The secondary battery of any one of the preceding clauses, wherein the cathode comprises an active intercalation material.

Clause 10. The secondary battery of any one of the preceding clauses, wherein the cathode comprises layered YMO₂, Y-rich layered Y₁₊ₓM₁₋ₓO₂, wherein YM₂O₄, olivine YMPO₄, silicate Y₂MSiO₄, borate YMBO₃, tavorite YMPO₄F (where M is Fe, Co, Ni, Mn, Cu, Cr, etc.), (where Y is Li, Na, K etc.), vanadium oxides, sulfur, lithium sulfide FeF₃, or LiSe.

Clause 11. The secondary battery of any one of the preceding clauses, wherein the cathode comprises an active lithium intercalation material.

Clause 12. The secondary battery of any one of the preceding clauses, wherein the cathode comprises lithium iron phosphate (LiFePO₄), lithium cobalt oxide (LiCoO₂), lithium manganese oxide (LiMn₂O₄), and lithium nickel oxide (LiNiO₂), lithium nickel cobalt manganese oxide (LiNiₓCo_{y}Mn_{z}O₂, 0.95≥x≥0.5, 0.3≥y≥0.025, 0.2≥z≥0.025), lithium nickel cobalt aluminum oxide (LiNiₓCo_{y}Al_{z}O₂, 0.95≥x≥0.5, 0.3≥y≥0.025, 0.2≥z≥0.025), or lithium nickel manganese spinel (LiNi_{0.5}Mn_{1.5}O₄).

Clause 13. The secondary battery of any one of the preceding clauses, wherein the cathode comprises a binder.

Clause 14. The secondary battery of any one of the preceding clauses, wherein the cathode comprises a polyvinylidene fluoride, polyacrylic acid, lotader, carboxymethyl cellulose, styrene-butadiene rubber, or sodium alginate.

Clause 15. The secondary battery of any one of the preceding clauses, wherein the cathode comprises an electrically conductive additive.

Clause 16. The secondary battery of any one of the preceding clauses, wherein the cathode comprises graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), or polyphenylene vinylene.

Clause 17. The secondary battery of any one of the preceding clauses, wherein the cathode comprises an ionic conductive media.

Clause 18. The secondary battery of any one of the preceding clauses, wherein the cathode comprises an ionic conductive media, wherein the ionic conductive media comprises a polymer, an ionic conductive ceramic, or a polymer-ceramic composite.

Clause 19. The secondary battery of any one of the preceding clauses, wherein the cathode comprises an ionic conductive media, wherein the ionic conductive media comprises a polymer, wherein the polymer comprises an ionic conductive polymer.

Clause 20. The secondary battery of any one of the preceding clauses, wherein the cathode comprises an ionic conductive media, wherein the ionic conductive media comprises a polymer, wherein the polymer comprises a nonionic conductive polymer.

Clause 21. The secondary battery of any one of the preceding clauses, wherein the cathode comprises an ionic conductive media, wherein the ionic conductive media comprises a polymer, wherein the polymer comprises at least one of polyethylene glycol, polyisobutene, polyvinylidene fluoride, and polyvinyl alcohol.

Clause 22. The secondary battery of any one of the preceding clauses, wherein the cathode comprises an ionic conductive media, wherein the ionic conductive media comprises a polymer, wherein the polymer comprises a polyolefin.

Clause 23. The secondary battery of any one of the preceding clauses, wherein the cathode comprises an ionic conductive media, wherein the ionic conductive media comprises a polymer, wherein the polymer comprises polyethylene, poly(butene-1), poly(n-pentene-2), polypropylene, or polytetrafluoroethylene.

Clause 24. The secondary battery of any one of the preceding clauses, wherein the cathode comprises an ionic conductive media, wherein the ionic conductive media comprises a polymer, wherein the polymer comprises a polyamine.

Clause 25. The secondary battery of any one of the preceding clauses, wherein the cathode comprises an ionic conductive media, wherein the ionic conductive media comprises a polymer, wherein the polymer comprises poly(ethylene imine) or polypropylene imine (PPI).

Clause 26. The secondary battery of any one of the preceding clauses, wherein the cathode comprises an ionic conductive media, wherein the ionic conductive media comprises a polymer, wherein the polymer comprises a polyamide.

Clause 27. The secondary battery of any one of the preceding clauses, wherein the cathode comprises an ionic conductive media, wherein the ionic conductive media comprises a polymer, wherein the polymer comprises polyamide (Nylon), poly(ε-caprolactam) (Nylon 6), or poly(hexamethylene adipamide) (Nylon 66).

Clause 28. The secondary battery of any one of the preceding clauses, wherein the cathode comprises an ionic conductive media, wherein the ionic conductive media comprises a polymer, wherein the polymer comprises a polyimide.

Clause 29. The secondary battery of any one of the preceding clauses, wherein the cathode comprises an ionic conductive media, wherein the ionic conductive media comprises a polymer, wherein the polymer comprises polyimide, polynitrile, and poly(pyromellitimide-1,4-diphenyl ether) Kapton, Nomex, or Kevlar.

Clause 30. The secondary battery of any one of the preceding clauses, wherein the cathode comprises an ionic conductive media, wherein the ionic conductive media comprises a polymer, wherein the polymer comprises polyether ether ketone (PEEK).

Clause 31. The secondary battery of any one of the preceding clauses, wherein the cathode comprises an ionic conductive media, wherein the ionic conductive media comprises a polymer, wherein the polymer comprises a vinyl polymer.

Clause 32. The secondary battery of any one of the preceding clauses, wherein the cathode comprises an ionic conductive media, wherein the ionic conductive media comprises a polymer, wherein the polymer comprises polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, or poly(isohexylcynaoacrylate).

Clause 33. The secondary battery of any one of the preceding clauses, wherein the cathode comprises an ionic conductive media, wherein the ionic conductive media comprises a polymer, wherein the polymer comprises a polyacetal.

Clause 34. The secondary battery of any one of the preceding clauses, wherein the cathode comprises an ionic conductive media, wherein the ionic conductive media comprises a polymer, wherein the polymer comprises a polyester.

Clause 35. The secondary battery of any one of the preceding clauses, wherein the cathode comprises an ionic conductive media, wherein the ionic conductive media comprises a polymer, wherein the polymer comprises polycarbonate, polybutylene terephthalate, or polyhydroxybutyrate.

Clause 36. The secondary battery of any one of the preceding clauses, wherein the cathode comprises an ionic conductive media, wherein the ionic conductive media comprises a polymer, wherein the polymer comprises a polyether.

Clause 37. The secondary battery of any one of the preceding clauses, wherein the cathode comprises an ionic conductive media, wherein the ionic conductive media comprises a polymer, wherein the polymer comprises poly(ethylene oxide) (PEO), poly(propylene oxide) (PPO), or poly(tetramethylene oxide) (PTMO).

Clause 38. The secondary battery of any one of the preceding clauses, wherein the cathode comprises an ionic conductive media, wherein the ionic conductive media comprises a polymer, wherein the polymer comprises a vinylidene polymer.

Clause 39. The secondary battery of any one of the preceding clauses, wherein the cathode comprises an ionic conductive media, wherein the ionic conductive media comprises a polymer, wherein the polymer comprises polyisobutylene, poly(methyl styrene), poly(methylmethacrylate) (PMMA), poly(vinylidene chloride), or poly(vinylidene fluoride).

Clause 40. The secondary battery of any one of the preceding clauses, wherein the cathode comprises an ionic conductive media, wherein the ionic conductive media comprises a polymer, wherein the polymer comprises a polyaramide.

Clause 41. The secondary battery of any one of the preceding clauses, wherein the cathode comprises an ionic conductive media, wherein the ionic conductive media comprises a polymer, wherein the polymer comprises poly(imino-1,3-phenylene iminoisophthaloyl) or poly(imino-1,4-phenylene iminoterephthaloyl).

Clause 42. The secondary battery of any one of the preceding clauses, wherein the cathode comprises an ionic conductive media, wherein the ionic conductive media comprises a polymer, wherein the polymer comprises a polyheteroaromatic compound.

Clause 43. The secondary battery of any one of the preceding clauses, wherein the cathode comprises an ionic conductive media, wherein the ionic conductive media comprises a polymer, wherein the polymer comprises polybenzimidazole (PBI), polybenzobisoxazole (PBT) or polybenzobisthiazole (PBT).

Clause 44. The secondary battery of any one of the preceding clauses, wherein the cathode comprises an ionic conductive media, wherein the ionic conductive media comprises a polymer, wherein the polymer comprises a polyheterocyclic compound.

Clause 45. The secondary battery of any one of the preceding clauses, wherein the cathode comprises an ionic conductive media, wherein the ionic conductive media comprises a polymer, wherein the polymer comprises polypyrrole.

Clause 46. The secondary battery of any one of the preceding clauses, wherein the cathode comprises an ionic conductive media, wherein the ionic conductive media comprises a polymer, wherein the polymer comprises a polyurethane.

Clause 47. The secondary battery of any one of the preceding clauses, wherein the cathode comprises an ionic conductive media, wherein the ionic conductive media comprises a polymer, wherein the polymer comprises a phenolic polymer.

Clause 48. The secondary battery of any one of the preceding clauses, wherein the cathode comprises an ionic conductive media, wherein the ionic conductive media comprises a polymer, wherein the polymer comprises phenol-formaldehyde.

Clause 49. The secondary battery of any one of the preceding clauses, wherein the cathode comprises an ionic conductive media, wherein the ionic conductive media comprises a polymer, wherein the polymer comprises a polyalkyne.

Clause 50. The secondary battery of any one of the preceding clauses, wherein the cathode comprises an ionic conductive media, wherein the ionic conductive media comprises a polymer, wherein the polymer comprises polyacetylene.

Clause 51. The secondary battery of any one of the preceding clauses, wherein the cathode comprises an ionic conductive media, wherein the ionic conductive media comprises a polymer, wherein the polymer comprises a polydiene.

Clause 52. The secondary battery of any one of the preceding clauses, wherein the cathode comprises an ionic conductive media, wherein the ionic conductive media comprises a polymer, wherein the polymer comprises 1,2-polybutadiene, cis-1,4-polybutadiene or trans-1,4-polybutadiene.

Clause 53. The secondary battery of any one of the preceding clauses, wherein the cathode comprises an ionic conductive media, wherein the ionic conductive media comprises a polymer, wherein the polymer comprises a polysiloxane.

Clause 54. The secondary battery of any one of the preceding clauses, wherein the cathode comprises an ionic conductive media, wherein the ionic conductive media comprises a polymer, wherein the polymer comprises poly(dimethylsiloxane) (PDMS), poly(diethylsiloxane) (PDES), polydiphenylsiloxane (PDPS), or polymethylphenylsiloxane (PMP S)

Clause 55. The secondary battery of any one of the preceding clauses, wherein the cathode comprises an ionic conductive media, wherein the ionic conductive media comprises a polymer, wherein the polymer comprises an inorganic polymer.

Clause 56. The secondary battery of any one of the preceding clauses, wherein the cathode comprises an ionic conductive media, wherein the ionic conductive media comprises a polymer, wherein the polymer comprises polyphosphazene.

Clause 57. The secondary battery of any one of the preceding clauses, wherein the cathode comprises an ionic conductive media, wherein the ionic conductive media comprises a polymer, wherein the polymer comprises a polyphosphonate.

Clause 58. The secondary battery of any one of the preceding clauses, wherein the cathode comprises an ionic conductive media, wherein the ionic conductive media comprises a polymer, wherein the polymer comprises a polysilane.

Clause 59. The secondary battery of any one of the preceding clauses, wherein the cathode comprises an ionic conductive media, wherein the ionic conductive media comprises a polymer, wherein the polymer comprises a polysilazane.

Clause 60. The secondary battery of any one of the preceding clauses, wherein the cathode comprises an ionic conductive salt.

Clause 61. The secondary battery of any one of the preceding clauses, wherein the cathode comprises a lithium ionic conductive salt.

Clause 62. The secondary battery of any one of the preceding clauses, wherein the cathode comprises lithium bis(trifluoromethanesulfonyl)imide (LiTFSI), lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), or LiNO₃.

Clause 63. The secondary battery of any one of the preceding clauses, wherein the cathode comprises a sodium ionic conductive salt.

Clause 64. The secondary battery of any one of the preceding clauses, wherein the cathode comprises sodium bis(trifluoromethanesulfonyl)imide (NaTFSI), sodium bis(fluorosulfonyl)imide (NaFSI), sodium bis(oxalato)borate (NaBOB), Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, or NaNO₃,

Clause 65. The secondary battery of any one of the preceding clauses, wherein the cathode comprises a magnesium ionic conductive salt.

Clause 66. The secondary battery of any one of the preceding clauses, wherein the cathode comprises magnesium bis(trifluoromethanesulfonyl)imide (Mg(TFSI)₂), magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, or Mg(CH₃COOH)₂.

Clause 67. The secondary battery of any one of the preceding clauses, wherein the cathode comprises a potassium ionic conductive salt.

Clause 68. The secondary battery of any one of the preceding clauses, wherein the cathode comprises potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), or KNO₃.

Clause 69. The secondary battery of any one of the preceding clauses, wherein the cathode comprises an aluminum ionic conductive salt.

Clause 70. The secondary battery of any one of the preceding clauses, wherein the cathode comprises Al(NO₃)₂, AlCl₃, Al₂(SO₄)₃, AlBr₃, AlI₃, AlN, AlSCN, or Al(ClO₄)₃.

Clause 71. The secondary battery of any one of the preceding clauses, wherein the cathode comprises an ionic conductive ceramic.

Clause 72. The secondary battery of any one of the preceding clauses, wherein the cathode comprises an ionic conductive ceramic that is ionic conductive to H⁺, Li⁺, Na⁺, K⁺, Ag⁺, Mg²⁺, Al³⁺, Zn²⁺, and combinations thereof.

Clause 73. The secondary battery of any one of the preceding clauses, wherein the cathode comprises a garnet-like structure oxide material.

Clause 74. The secondary battery of any one of the preceding clauses, wherein the cathode comprises a garnet-like structure oxide material with the general formula:

Liₙ[A(_{3-a′-a″)}A′(_{a′})A″(_{a″})][B(_{2-b′-b″})B′(_{b′})B″(_{b″})][C′(_{c′})C″(_{c″})]O₁₂,
a. where A, A′, and A″ stand for an dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;
b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;
c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and
d. wherein n=7+a′+2·a″−b′−2·b″−3·c′−4·c″ and 4.5≤n≤7.5. comprises a perovskite-type oxide.

Clause 75. The secondary battery of any one of the preceding clauses, wherein the cathode comprises (Li,La)TiO₃ or (Li,La)TiO₃ with doped or replaced compounds.

Clause 76. The secondary battery of any one of the preceding clauses, wherein the cathode comprises NASICON-structured lithium membrane.

Clause 77. The secondary battery of any one of the preceding clauses, wherein the cathode comprises LAGP (Li₁-xAlₓGe₂₋ₓ(PO₄)₃).

Clause 78. The secondary battery of any one of the preceding clauses, wherein the cathode comprises LAGP (Li₁-xAlₓGe₂₋ₓ(PO₄)₃) with other elements doped therein.

Clause 79. The secondary battery of any one of the preceding clauses, wherein the cathode comprises LATP (Li₁+xAlₓTi₂₋ₓ(PO₄)₃)

Clause 80. The secondary battery of any one of the preceding clauses, wherein the cathode comprises LATP (Li₁+xAlₓTi₂₋ₓ(PO₄)₃) with other elements doped therein.

Clause 81. The secondary battery of any one of the preceding clauses, wherein the cathode comprises an anti-perovskite structure material or derivative thereof.

Clause 82. The secondary battery of any one of the preceding clauses, wherein the cathode comprises a Li₃OCl, Li₃OBr, or Li₃OI.

Clause 83. The secondary battery of any one of the preceding clauses, wherein the cathode comprises a material from the Li₃YH₆(H═F, Cl, Br, I) family of materials, wherein Y can be replaced by other rare earth elements.

Clause 84. The secondary battery of any one of the preceding clauses, wherein the cathode comprises Li₂ₓS_{x+w+5z}M_{y}P_{2z}, wherein x is 8-16, y is 0.1-6, w is 0.1-15, z is 0.1-3, and wherein M is selected from the group consisting of lanthanides, Group 3, Group 4, Group 5, Group 6, Group 7, Group 8, Group 9, Group 12, Group 13, and Group 14 atoms, and combinations thereof.

Clause 85. The secondary battery of any one of the preceding clauses, wherein the cathode comprises an argyrodites material.

Clause 86. The secondary battery of any one of the preceding clauses, wherein the cathode comprises an argyrodites material with the general formula: Li₁₂₋ₘ₋ₓ(MₘY₄²⁻)Y₂₋ₓ^{2-X}ₓ⁻, wherein M^{m+}=B³⁺, Ga³⁺, Sb⁺, Si⁴⁺, Ge⁴⁺, P⁵⁺, As⁵⁺, or a combination thereof; Y²⁻═O²⁻, S²⁻, Se²⁻, Te²⁻, or a combination thereof; X⁻═F⁻, Cl⁻, Br⁻, I⁻, or a combination thereof; and x is in the range of 0≤x≤2.

Clause 87. The secondary battery of any one of the preceding clauses, wherein the cathode has a coating thereon.

Clause 88. The secondary battery of any one of the preceding clauses, wherein the anode comprises a metal or metal-alloy anode.

Clause 89. The secondary battery of any one of the preceding clauses, wherein the anode comprises lithium metal, lithium metal alloy, sodium metal, sodium metal alloy, magnesium metal, magnesium metal alloy, aluminum metal, aluminum metal alloy, potassium metal, potassium metal alloy, zinc metal, or zinc metal alloy.

Clause 90. The secondary battery of any one of the preceding clauses, wherein the anode comprises indium or manganese.

Clause 91. The secondary battery of any one of the preceding clauses, wherein the anode comprises a composite anode.

Clause 92. The secondary battery of any one of the preceding clauses, wherein the anode comprises an active material.

Clause 93. The secondary battery of any one of the preceding clauses, wherein the anode comprises titanium oxide, silicon, tin oxide, germanium, antimony, silicon oxide, iron oxide, cobalt oxide, ruthenium oxide, molybdenum oxide, molybdenum sulfide, chromium oxide, nickel oxide, or manganese oxide.

Clause 94. The secondary battery of any one of the preceding clauses, wherein the anode comprises carbon-based materials.

Clause 95. The secondary battery of any one of the preceding clauses, wherein the anode comprises hard carbon, soft carbon, graphene, graphite, carbon nanofibers, or carbon nanotubes.

Clause 96. The secondary battery of any one of the preceding clauses, wherein the anode comprises a binder.

Clause 97. The secondary battery of any one of the preceding clauses, wherein the anode comprises polyvinylidene fluoride, polyacrylic acid, carboxymethyl cellulose, styrene-butadiene rubber, or sodium alginate.

Clause 98. The secondary battery of any one of the preceding clauses, wherein the anode comprises an electrically conductive additive.

Clause 99. The secondary battery of any one of the preceding clauses, wherein the anode comprises graphene, reduced graphene oxide, carbon nanotubes, carbon black, Super P, acetylene black, or carbon nanofibers.

Clause 100. The secondary battery of any one of the preceding clauses, wherein the anode comprises a conductive polymer.

Clause 101. The secondary battery of any one of the preceding clauses, wherein the anode comprises polyaniline, polypyrrole, poly(3,4-ethylenedioxythiophene (PEDOT), or polyphenylene vinylene.

Clause 102. The secondary battery of any one of the preceding clauses, wherein the anode comprises an ionic conductive media.

Clause 103. The secondary battery of any one of the preceding clauses, wherein the anode comprises an ionic conductive media.

Clause 104. The secondary battery of any one of the preceding clauses, wherein the anode comprises an ionic conductive media, wherein the ionic conductive media comprises a polymer, an ionic conductive ceramic, or a polymer-ceramic composite.

Clause 105. The secondary battery of any one of the preceding clauses, wherein the anode comprises an ionic conductive media, wherein the ionic conductive media comprises a polymer, wherein the polymer comprises an ionic conductive polymer.

Clause 106. The secondary battery of any one of the preceding clauses, wherein the anode comprises an ionic conductive media, wherein the ionic conductive media comprises a polymer, wherein the polymer comprises a nonionic conductive polymer.

Clause 107. The secondary battery of any one of the preceding clauses, wherein the anode comprises an ionic conductive media, wherein the ionic conductive media comprises a polymer, wherein the polymer comprises at least one of polyethylene glycol, polyisobutene, polyvinylidene fluoride, and polyvinyl alcohol.

Clause 108. The secondary battery of any one of the preceding clauses, wherein the anode comprises an ionic conductive media, wherein the ionic conductive media comprises a polymer, wherein the polymer comprises a polyolefin.

Clause 109. The secondary battery of any one of the preceding clauses, wherein the anode comprises an ionic conductive media, wherein the ionic conductive media comprises a polymer, wherein the polymer comprises polyethylene, poly(butene-1), poly(n-pentene-2), polypropylene, or polytetrafluoroethylene.

Clause 110. The secondary battery of any one of the preceding clauses, wherein the anode comprises an ionic conductive media, wherein the ionic conductive media comprises a polymer, wherein the polymer comprises a polyamine.

Clause 111. The secondary battery of any one of the preceding clauses, wherein the anode comprises an ionic conductive media, wherein the ionic conductive media comprises a polymer, wherein the polymer comprises poly(ethylene imine) or polypropylene imine (PPI).

Clause 112. The secondary battery of any one of the preceding clauses, wherein the anode comprises an ionic conductive media, wherein the ionic conductive media comprises a polymer, wherein the polymer comprises a polyamide.

Clause 113. The secondary battery of any one of the preceding clauses, wherein the anode comprises an ionic conductive media, wherein the ionic conductive media comprises a polymer, wherein the polymer comprises polyamide (Nylon), poly(ε-caprolactam) (Nylon 6), or poly(hexamethylene adipamide) (Nylon 66).

Clause 114. The secondary battery of any one of the preceding clauses, wherein the anode comprises an ionic conductive media, wherein the ionic conductive media comprises a polymer, wherein the polymer comprises a polyimide.

Clause 115. The secondary battery of any one of the preceding clauses, wherein the anode comprises an ionic conductive media, wherein the ionic conductive media comprises a polymer, wherein the polymer comprises polyimide, polynitrile, and poly(pyromellitimide-1,4-diphenyl ether) Kapton, Nomex, or Kevlar.

Clause 116. The secondary battery of any one of the preceding clauses, wherein the anode comprises an ionic conductive media, wherein the ionic conductive media comprises a polymer, wherein the polymer comprises polyether ether ketone (PEEK).

Clause 117. The secondary battery of any one of the preceding clauses, wherein the anode comprises an ionic conductive media, wherein the ionic conductive media comprises a polymer, wherein the polymer comprises a vinyl polymer.

Clause 118. The secondary battery of any one of the preceding clauses, wherein the anode comprises an ionic conductive media, wherein the ionic conductive media comprises a polymer, wherein the polymer comprises polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, or poly(isohexylcynaoacrylate).

Clause 119. The secondary battery of any one of the preceding clauses, wherein the anode comprises an ionic conductive media, wherein the ionic conductive media comprises a polymer, wherein the polymer comprises a polyacetal.

Clause 120. The secondary battery of any one of the preceding clauses, wherein the anode comprises an ionic conductive media, wherein the ionic conductive media comprises a polymer, wherein the polymer comprises a polyester.

Clause 121. The secondary battery of any one of the preceding clauses, wherein the anode comprises an ionic conductive media, wherein the ionic conductive media comprises a polymer, wherein the polymer comprises polycarbonate, polybutylene terephthalate, or polyhydroxybutyrate.

Clause 122. The secondary battery of any one of the preceding clauses, wherein the anode comprises an ionic conductive media, wherein the ionic conductive media comprises a polymer, wherein the polymer comprises a polyether.

Clause 123. The secondary battery of any one of the preceding clauses, wherein the anode comprises an ionic conductive media, wherein the ionic conductive media comprises a polymer, wherein the polymer comprises poly(ethylene oxide) (PEO), poly(propylene oxide) (PPO), or poly(tetramethylene oxide) (PTMO).

Clause 124. The secondary battery of any one of the preceding clauses, wherein the anode comprises an ionic conductive media, wherein the ionic conductive media comprises a polymer, wherein the polymer comprises a vinylidene polymer.

Clause 125. The secondary battery of any one of the preceding clauses, wherein the anode comprises an ionic conductive media, wherein the ionic conductive media comprises a polymer, wherein the polymer comprises polyisobutylene, poly(methyl styrene), poly(methylmethacrylate) (PMMA), poly(vinylidene chloride), or poly(vinylidene fluoride).

Clause 126. The secondary battery of any one of the preceding clauses, wherein the anode comprises an ionic conductive media, wherein the ionic conductive media comprises a polymer, wherein the polymer comprises a polyaramide.

Clause 127. The secondary battery of any one of the preceding clauses, wherein the anode comprises an ionic conductive media, wherein the ionic conductive media comprises a polymer, wherein the polymer comprises poly(imino-1,3-phenylene iminoisophthaloyl) or poly(imino-1,4-phenylene iminoterephthaloyl).

Clause 128. The secondary battery of any one of the preceding clauses, wherein the anode comprises an ionic conductive media, wherein the ionic conductive media comprises a polymer, wherein the polymer comprises a polyheteroaromatic compound.

Clause 129. The secondary battery of any one of the preceding clauses, wherein the anode comprises an ionic conductive media, wherein the ionic conductive media comprises a polymer, wherein the polymer comprises polybenzimidazole (PBI), polybenzobisoxazole (PBT) or polybenzobisthiazole (PBT).

Clause 130. The secondary battery of any one of the preceding clauses, wherein the anode comprises an ionic conductive media, wherein the ionic conductive media comprises a polymer, wherein the polymer comprises a polyheterocyclic compound.

Clause 131. The secondary battery of any one of the preceding clauses, wherein the anode comprises an ionic conductive media, wherein the ionic conductive media comprises a polymer, wherein the polymer comprises polypyrrole.

Clause 132. The secondary battery of any one of the preceding clauses, wherein the anode comprises an ionic conductive media, wherein the ionic conductive media comprises a polymer, wherein the polymer comprises a polyurethane.

Clause 133. The secondary battery of any one of the preceding clauses, wherein the anode comprises an ionic conductive media, wherein the ionic conductive media comprises a polymer, wherein the polymer comprises a phenolic polymer.

Clause 134. The secondary battery of any one of the preceding clauses, wherein the anode comprises an ionic conductive media, wherein the ionic conductive media comprises a polymer, wherein the polymer comprises phenol-formaldehyde.

Clause 135. The secondary battery of any one of the preceding clauses, wherein the anode comprises an ionic conductive media, wherein the ionic conductive media comprises a polymer, wherein the polymer comprises a polyalkyne.

Clause 136. The secondary battery of any one of the preceding clauses, wherein the anode comprises an ionic conductive media, wherein the ionic conductive media comprises a polymer, wherein the polymer comprises polyacetylene.

Clause 137. The secondary battery of any one of the preceding clauses, wherein the anode comprises an ionic conductive media, wherein the ionic conductive media comprises a polymer, wherein the polymer comprises a polydiene.

Clause 138. The secondary battery of any one of the preceding clauses, wherein the anode comprises an ionic conductive media, wherein the ionic conductive media comprises a polymer, wherein the polymer comprises 1,2-polybutadiene, cis-1,4-polybutadiene or trans-1,4-polybutadiene.

Clause 139. The secondary battery of any one of the preceding clauses, wherein the anode comprises an ionic conductive media, wherein the ionic conductive media comprises a polymer, wherein the polymer comprises a polysiloxane.

Clause 140. The secondary battery of any one of the preceding clauses, wherein the anode comprises an ionic conductive media, wherein the ionic conductive media comprises a polymer, wherein the polymer comprises poly(dimethylsiloxane) (PDMS), poly(diethylsiloxane) (PDES), polydiphenylsiloxane (PDPS), or polymethylphenylsiloxane (PMPS).

Clause 141. The secondary battery of any one of the preceding clauses, wherein the anode comprises an ionic conductive media, wherein the ionic conductive media comprises a polymer, wherein the polymer comprises an inorganic polymer.

Clause 142. The secondary battery of any one of the preceding clauses, wherein the anode comprises an ionic conductive media, wherein the ionic conductive media comprises a polymer, wherein the polymer comprises polyphosphazene.

Clause 143. The secondary battery of any one of the preceding clauses, wherein the anode comprises an ionic conductive media, wherein the ionic conductive media comprises a polymer, wherein the polymer comprises a polyphosphonate.

Clause 144. The secondary battery of any one of the preceding clauses, wherein the anode comprises an ionic conductive media, wherein the ionic conductive media comprises a polymer, wherein the polymer comprises a polysilane.

Clause 145. The secondary battery of any one of the preceding clauses, wherein the anode comprises an ionic conductive media, wherein the ionic conductive media comprises a polymer, wherein the polymer comprises a polysilazane.

Clause 146. The secondary battery of any one of the preceding clauses, wherein the anode comprises an ionic conductive salt.

Clause 147. The secondary battery of any one of the preceding clauses, wherein the anode comprises a lithium ionic conductive salt.

Clause 148. The secondary battery of any one of the preceding clauses, wherein the anode comprises lithium bis(trifluoromethanesulfonyl)imide (LiTFSI), lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), or LiNO₃.

Clause 149. The secondary battery of any one of the preceding clauses, wherein the anode comprises a sodium ionic conductive salt.

Clause 150. The secondary battery of any one of the preceding clauses, wherein the anode comprises sodium bis(trifluoromethanesulfonyl)imide (NaTFSI), sodium bis(fluorosulfonyl)imide (NaFSI), sodium bis(oxalato)borate (NaBOB), Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, or NaNO₃,

Clause 151. The secondary battery of any one of the preceding clauses, wherein the anode comprises a magnesium ionic conductive salt.

Clause 152. The secondary battery of any one of the preceding clauses, wherein the anode comprises magnesium bis(trifluoromethanesulfonyl)imide (Mg(TFSI)₂), magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, or Mg(CH₃COOH)₂.

Clause 153. The secondary battery of any one of the preceding clauses, wherein the anode comprises a potassium ionic conductive salt.

Clause 154. The secondary battery of any one of the preceding clauses, wherein the anode comprises potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), or KNO₃.

Clause 155. The secondary battery of any one of the preceding clauses, wherein the anode comprises an aluminum ionic conductive salt.

Clause 156. The secondary battery of any one of the preceding clauses, wherein the anode comprises Al(NO₃)₂, AlCl₃, Al₂(SO₄)₃, AlBr₃, AlI₃, AlN, AlSCN, or Al(ClO₄)₃.

Clause 157. The secondary battery of any one of the preceding clauses, wherein the anode comprises an ionic conductive ceramic.

Clause 158. The secondary battery of any one of the preceding clauses, wherein the anode comprises an ionic conductive ceramic that is ionic conductive to H⁺, Li⁺, Na⁺, K⁺, Ag⁺, Mg²⁺, Al³⁺, Zn²⁺, and combinations thereof.

Clause 159. The secondary battery of any one of the preceding clauses, wherein the anode comprises a garnet-like structure oxide material.

Clause 160. The secondary battery of any one of the preceding clauses, wherein the anode comprises a garnet-like structure oxide material with the general formula:

Liₙ[A(_{3-a′-a″)}A′(_{a′})A″(_{a″})][B(_{2-b′-b″})B′(_{b′})B″(_{b″})][C′(_{c′})C″(_{c″})]O₁₂,
a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;
b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;
c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and
d. wherein n=7+a′+2·a″−b′−2·b″−3·c′−4·c″ and 4.5≤n≤7.5. comprises a perovskite-type oxide.

Clause 161. The secondary battery of any one of the preceding clauses, wherein the anode comprises (Li,La)TiO₃ or (Li,La)TiO₃ with doped or replaced compounds.

Clause 162. The secondary battery of any one of the preceding clauses, wherein the anode comprises NASICON-structured lithium membrane.

Clause 163. The secondary battery of any one of the preceding clauses, wherein the anode comprises LAGP (Li₁-xAlₓGe₂₋ₓ(PO₄)₃).

Clause 164. The secondary battery of any one of the preceding clauses, wherein the anode comprises LAGP (Li₁-xAlₓGe₂₋ₓ(PO₄)₃) with other elements doped therein.

Clause 165. The secondary battery of any one of the preceding clauses, wherein the anode comprises LATP (Li₁+xAlₓTi₂₋ₓ(PO₄)₃)

Clause 166. The secondary battery of any one of the preceding clauses, wherein the anode comprises LATP (Li₁+xAlₓTi₂₋ₓ(PO₄)₃) with other elements doped therein.

Clause 167. The secondary battery of any one of the preceding clauses, wherein the anode comprises an anti-perovskite structure material or derivative thereof.

Clause 168. The secondary battery of any one of the preceding clauses, wherein the anode comprises a Li₃OCl, Li₃OBr, or Li₃OI.

Clause 169. The secondary battery of any one of the preceding clauses, wherein the anode comprises a material from the Li₃YH₆(H═F, Cl, Br, I) family of materials, wherein Y can be replaced by other rare earth elements.

Clause 170. The secondary battery of any one of the preceding clauses, wherein the anode comprises Li₂ₓS_{x+w+5z}M_{y}P_{2z}, wherein x is 8-16, y is 0.1-6, w is 0.1-15, z is 0.1-3, and wherein M is selected from the group consisting of lanthanides, Group 3, Group 4, Group 5, Group 6, Group 7, Group 8, Group 9, Group 12, Group 13, and Group 14 atoms, and combinations thereof.

Clause 171. The secondary battery of any one of the preceding clauses, wherein the anode comprises an argyrodites material.

Clause 172. The secondary battery of any one of the preceding clauses, wherein the anode comprises an argyrodites material with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻═O²⁻, S²⁻, Se²⁻, Te²⁻, or a combination thereof; X⁻═F⁻, Cl⁻, Br⁻, I⁻, or a combination thereof; and x is in the range of 0≤x≤2.

Clause 173. The secondary battery of any one of the preceding clauses, wherein the anode has a coating thereon.

Clause 174. The secondary battery of any one of the preceding clauses, further comprising a liquid-based electrolyte.

Clause 175. The secondary battery of any one of the preceding clauses, further comprising an organic-based liquid electrolyte.

Clause 176. The secondary battery of any one of the preceding clauses, further comprising an organic-based liquid electrolyte, the organic-based liquid electrolyte comprising ethylene carbonate (EC), fluoroethylene carbonate (FEC), propylene carbonate (PC), ethyl-methyl carbonate (EMC), dimethyl carbonate (DMC), diethyl carbonate (DEC), dimethyl ether (DME), diethylene glycol dimethyl ether (DEGDME), tetraethylene glycol dimethyl ether (TEGDME), 1,3-dioxolane (DOL), or 1-ethyl-3-methylimidoxzoium chloride.

Clause 177. The secondary battery of any one of the preceding clauses, further comprising a room temperature ionic liquid electrolyte.

Clause 178. The secondary battery of any one of the preceding clauses, further comprising a room temperature ionic liquid electrolyte, the room temperature ionic liquid electrolyte comprising imidazolium, pyrrolidinium, piperidinium, ammonium, hexafluorophosphate, dicyanamide, tetrachloroaluminate, sulfonium, phosphonium, pyridinium, parazonium or thiazolium.

Clause 179. The secondary battery of any one of the preceding clauses, wherein the liquid electrolyte comprises a lithium ionic conductive salt.

Clause 180. The secondary battery of any one of the preceding clauses, wherein the liquid electrolyte comprises lithium bis(trifluoromethanesulfonyl)imide (LiTFSI), lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), or LiNO₃.

Clause 181. The secondary battery of any one of the preceding clauses, wherein the liquid electrolyte comprises a sodium ionic conductive salt.

Clause 182. The secondary battery of any one of the preceding clauses, wherein the liquid electrolyte comprises sodium bis(trifluoromethanesulfonyl)imide (NaTFSI), sodium bis(fluorosulfonyl)imide (NaFSI), sodium bis(oxalato)borate (NaBOB), Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, or NaNO₃,

Clause 183. The secondary battery of any one of the preceding clauses, wherein the liquid electrolyte comprises a magnesium ionic conductive salt.

Clause 184. The secondary battery of any one of the preceding clauses, wherein the liquid electrolyte comprises magnesium bis(trifluoromethanesulfonyl)imide (Mg(TFSI)₂), magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, or Mg(CH₃COOH)₂.

Clause 185. The secondary battery of any one of the preceding clauses, wherein the liquid electrolyte comprises a potassium ionic conductive salt.

Clause 186. The secondary battery of any one of the preceding clauses, wherein the liquid electrolyte comprises potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), or KNO₃.

Clause 187. The secondary battery of any one of the preceding clauses, wherein the liquid electrolyte comprises an aluminum ionic conductive salt.

Clause 188. The secondary battery of any one of the preceding clauses, wherein the liquid electrolyte comprises Al(NO₃)₂, AlCl₃, Al₂(SO₄)₃, AlBr₃, AlI₃, AlN, AlSCN, or Al(ClO₄)₃.

Clause 189. The secondary battery of any one of clauses 1 to 173 excluding any liquid-based electrolyte.

Clause 1. A method for manufacturing a solid-state electrolyte membrane, the method comprising coating a ceramic-polymer composite solid-state electrolyte on a fabric support.

Clause 2. The method of clause 1, wherein coating a ceramic-polymer composite solid-state electrolyte on the fabric support includes coating a ceramic-polymer composite solid-state electrolyte slurry on the fabric support.

Clause 3. The method of clause 1, wherein coating a ceramic-polymer composite solid-state electrolyte on the fabric support includes coating a ceramic-polymer composite solid-state electrolyte slurry on a stationary fabric support.

Clause 4. The method of clause 1, wherein coating a ceramic-polymer composite solid-state electrolyte on the fabric support includes coating a ceramic-polymer composite solid-state electrolyte slurry on a continuously rolling fabric support.

Clause 5. The method of clause 1, wherein coating a ceramic-polymer composite solid-state electrolyte on the fabric support includes coating a ceramic-polymer composite solid-state electrolyte slurry on a continuously rolling fabric support in a roll-to-roll process.

Clause 6. The method of any one of clauses 1 to 5, wherein coating a ceramic-polymer composite solid-state electrolyte on the fabric support includes gravure printing.

Clause 7. The method of any one of clauses 1 to 5, wherein coating a ceramic-polymer composite solid-state electrolyte on the fabric support includes ink jet coating.

Clause 8. The method of any one of clauses 1 to 5, wherein coating a ceramic-polymer composite solid-state electrolyte on the fabric support includes slurry casting.

Clause 9. The method of any one of clauses 1 to 5, wherein coating a ceramic-polymer composite solid-state electrolyte on the fabric support includes doctor blade casting.

Clause 10. The method of any one of clauses 1 to 5, wherein coating a ceramic-polymer composite solid-state electrolyte on the fabric support includes spraying.

Clause 11. The method of any one of clauses 1 to 5, wherein coating a ceramic-polymer composite solid-state electrolyte on the fabric support includes knife-over-edge coating.

Clause 12. The method of any one of clauses 1 to 5, wherein coating a ceramic-polymer composite solid-state electrolyte on the fabric support includes dip coating.

Clause 13. The method of any one of clauses 1 to 5, wherein coating a ceramic-polymer composite solid-state electrolyte on the fabric support includes slot-die coating.

Clause 14. The method of any one of clauses 1 to 13, wherein coating a ceramic-polymer composite solid-state electrolyte on the fabric support includes coating the fabric support without visible regions of bare fabric support.

Clause 15. The method of any one of clauses 1 to 13, wherein coating a ceramic-polymer composite solid-state electrolyte on the fabric support includes pattern coating the fabric support with visible regions of bare fabric support between each print.

Clause 16. The method of any of the preceding clauses, further comprising drying the coated ceramic-polymer composite solid-state electrolyte.

Clause 17. The method of any of the preceding clauses further comprising calendering the dried ceramic-polymer composite solid-state electrolyte.

Clause 18. The method of any one of clauses 1 to 17, wherein the fabric support is electrically insulating.

Clause 19. The method of any one of clauses 1 to 17, wherein the fabric support is electrically conductive.

Clause 20. The method of any one of clauses 1 to 17, wherein the fabric support is electrically conductive with an electrically insulative coating.

Clause 21. The method of any one of clauses 1 to 20, wherein the fabric support is ionic conductive.

Clause 22. The method of any one of clauses 1 to 20, wherein the fabric support is nonionic conductive.

Clause 23. The method of any one of the preceding clauses, wherein the fabric support comprises fibers.

Clause 24. The method of any one of the preceding clauses, wherein the fabric support comprises natural fibers.

Clause 25. The method of any one of the preceding clauses, wherein the fabric support comprises plant fibers.

Clause 26. The method of any one of the preceding clauses, wherein the fabric support comprises bast fibers.

Clause 27. The method of any one of the preceding clauses, wherein the fabric support comprises leaf fibers.

Clause 28. The method of any one of the preceding clauses, wherein the fabric support comprises husk fibers.

Clause 29. The method of any one of the preceding clauses, wherein the fabric support comprises animal fibers.

Clause 30. The method of any one of the preceding clauses, wherein the fabric support comprises at least one of cotton, stem, flux, hemp, sisal, coconut, wool, silk, cashmere, chitin, chitosan, collagen, keratin, furs, and combinations thereof.

Clause 31. The method of any one of the preceding clauses, wherein the fabric support comprises synthetic fibers.

Clause 32. The method of any one of the preceding clauses, wherein the fabric support comprises at least one of polyesters, polyimides (PI), polyolefins, polyvinyl chloride (PVC), polyvinylidene chloride (PVDC), poly(methyl methacrylate) (PMMA), polyvinylidene fluoride (PVDF), polyether-polyurea copolymer, polyvinyl alcohol (PVA), polybenzimidazole, polyacrylonitrile (PAN), polyphenylene sulfide (PPS), poly(lactic acid), polyhydroquinone-diimidazopyridine, polyparaphenylene benzobisthiazole (PBT), polyparaphenylene benzobisimidazole (PBI), polyethylene terephthalate (PET), polyparaphenylenebenzobisoxazole (PBO), poly(p-phenylene-2,6-benzobisoxazole), Kevlar, 6-nylon, 66-nylon, acrylic fibers, cellulose fibers, polyethylene naphthalate, polyether ether ketone, modified polyphenylene ether (PPE), glass fiber, fiberglass, liquid crystal polymer and combinations thereof.

Clause 33. The method of any one of the preceding clauses, wherein the fabric support comprises a textile-based fabric.

Clause 34. The method of any one of the preceding clauses, wherein the fabric support is non-woven.

Clause 35. The method of any one of the preceding clauses, wherein the fabric support comprises at least one of satin, denim, crepel, fleece, polyester, linen, velvet, damas, cheesecloth, chiffon, rayon, baize, batiste, chameuse, chenille, cheviot, felt, twill, velvet, jersey, lace, lycra, polycotton, and combinations thereof.

Clause 36. The method of any one of the preceding clauses, wherein the fabric support comprises a textile-based fabric fabricated by at least one of weaving, knitting, crocheting, knotting, tatting, felting, braiding, electrospinning, and electrospraying.

Clause 37. The method of any one of the preceding clauses, wherein the fabric support comprises a textile-based fabric fabricated by 3D printing.

Clause 38. The method of any one of the preceding clauses, wherein the fabric support comprises metal.

Clause 39. The method of any one of the preceding clauses, wherein the fabric support comprises at least one of copper, aluminum, stainless steel, nickel, titanium, vanadium, iron, cobalt, zinc, molybdenum, niobium, and combinations thereof.

Clause 40. The method of any one of the preceding clauses, wherein the fabric support comprises a metal-mesh-based fabric.

Clause 41. The method of any one of the preceding clauses, wherein the fabric support comprises a metal-mesh-based fabric, the metal comprising at least one of copper, aluminum, stainless steel, nickel, titanium, vanadium, iron, cobalt, zinc, molybdenum, niobium, and combinations thereof.

Clause 42. The method of any one of the preceding clauses, wherein the fabric support comprises a metal-mesh-based fabric fabricated by welding, weaving, or 3D printing.

Clause 43. The method of any one of the preceding clauses, wherein the fabric support comprises an electrically insulating layer on the metal-mesh-based fabric.

Clause 44. The method of any one of the preceding clauses, wherein the fabric support comprises an electrically insulating layer on the metal-mesh-based fabric, and wherein the electrically insulating layer comprises at least one of a polymer, a metal oxide, a ceramic, and combinations thereof.

Clause 45. The method of any one of clauses 43 to 44, wherein the electrically insulating layer has a thickness ranging from 1<t<1000 nm.

Clause 46. The method of any one of clauses 43 to 44, wherein the electrically insulating layer has a thickness ranging from 5<t<100 nm.

Clause 47. The method of any one of the preceding clauses, wherein the fabric support has a thickness ranging from 0.01<t<1000 μm.

Clause 48. The method of any one of the preceding clauses, wherein the fabric support has a thickness ranging from 0.1<t<500 μm.

Clause 49. The method of any one of the preceding clauses, wherein the ceramic-polymer composite solid-state electrolyte comprises an organic solvent.

Clause 50. The method of any one of the preceding clauses, wherein the ceramic-polymer composite solid-state electrolyte comprises an ionic conductive organic solvent.

Clause 51. The method of any one of the preceding clauses, wherein the ceramic-polymer composite solid-state electrolyte comprises a nonionic conductive organic solvent.

Clause 52. The method of any one of the preceding clauses, wherein the ceramic-polymer composite solid-state electrolyte comprises ethanol, methanol, acetone, hexane, chloroform, dimethylformamide, benzene, or toluene.

Clause 53. The method of any one of the preceding clauses, wherein the ceramic-polymer composite solid-state electrolyte comprises a polymer.

Clause 54. The method of any one of the preceding clauses, wherein the ceramic-polymer composite solid-state electrolyte comprises a solvent and a polymer capable of dissolving in the solvent.

Clause 55. The method of any one of the preceding clauses, wherein the ceramic-polymer composite solid-state electrolyte comprises an ionic conductive polymer.

Clause 56. The method of any one of the preceding clauses, wherein the ceramic-polymer composite solid-state electrolyte comprises an nonionic conductive polymer.

Clause 57. The method of any one of the preceding clauses, wherein the ceramic-polymer composite solid-state electrolyte comprises at least one of polyethylene glycol, polyisobutene, polyvinylidene fluoride, and polyvinyl alcohol.

Clause 58. The method of any one of the preceding clauses, wherein the ceramic-polymer composite solid-state electrolyte comprises a polyolefin.

Clause 59. The method of any one of the preceding clauses, wherein the ceramic-polymer composite solid-state electrolyte comprises polyethylene, poly(butene-1), poly(n-pentene-2), polypropylene, or polytetrafluoroethylene.

Clause 60. The method of any one of the preceding clauses, wherein the ceramic-polymer composite solid-state electrolyte comprises a polyamine.

Clause 61. The method of any one of the preceding clauses, wherein the ceramic-polymer composite solid-state electrolyte comprises poly(ethylene imine) or polypropylene imine (PPI).

Clause 62. The method of any one of the preceding clauses, wherein the ceramic-polymer composite solid-state electrolyte comprises a polyamide.

Clause 63. The method of any one of the preceding clauses, wherein the ceramic-polymer composite solid-state electrolyte comprises polyamide (Nylon), poly(ε-caprolactam) (Nylon 6), or poly(hexamethylene adipamide) (Nylon 66).

Clause 64. The method of any one of the preceding clauses, wherein the ceramic-polymer composite solid-state electrolyte comprises a polyimide.

Clause 65. The method of any one of the preceding clauses, wherein the ceramic-polymer composite solid-state electrolyte comprises polyimide, polynitrile, and poly(pyromellitimide-1,4-diphenyl ether) Kapton, Nomex, or Kevlar.

Clause 66. The method of any one of the preceding clauses, wherein the ceramic-polymer composite solid-state electrolyte comprises polyether ether ketone (PEEK).

Clause 67. The method of any one of the preceding clauses, wherein the ceramic-polymer composite solid-state electrolyte comprises a vinyl polymer.

Clause 68. The method of any one of the preceding clauses, wherein the ceramic-polymer composite solid-state electrolyte comprises polyacryl amide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, or poly(isohexylcynaoacrylate).

Clause 69. The method of any one of the preceding clauses, wherein the ceramic-polymer composite solid-state electrolyte comprises a polyacetal.

Clause 70. The method of any one of the preceding clauses, wherein the ceramic-polymer composite solid-state electrolyte comprises a polyester.

Clause 71. The method of any one of the preceding clauses, wherein the ceramic-polymer composite solid-state electrolyte comprises polycarbonate, polybutylene terephthalate, or polyhydroxybutyrate.

Clause 72. The method of any one of the preceding clauses, wherein the ceramic-polymer composite solid-state electrolyte comprises a polyether.

Clause 73. The method of any one of the preceding clauses, wherein the ceramic-polymer composite solid-state electrolyte comprises poly(ethylene oxide) (PEO), poly(propylene oxide) (PPO), or poly(tetramethylene oxide) (PTMO).

Clause 74. The method of any one of the preceding clauses, wherein the ceramic-polymer composite solid-state electrolyte comprises a vinylidene polymer.

Clause 75. The method of any one of the preceding clauses, wherein the ceramic-polymer composite solid-state electrolyte comprises polyisobutylene, poly(methyl styrene), poly(methylmethacrylate) (PMMA), poly(vinylidene chloride), or poly(vinylidene fluoride).

Clause 76. The method of any one of the preceding clauses, wherein the ceramic-polymer composite solid-state electrolyte comprises a polyaramide.

Clause 77. The method of any one of the preceding clauses, wherein the ceramic-polymer composite solid-state electrolyte comprises poly(imino-1,3-phenylene iminoisophthaloyl) or poly(imino-1,4-phenylene iminoterephthaloyl).

Clause 78. The method of any one of the preceding clauses, wherein the ceramic-polymer composite solid-state electrolyte comprises a polyheteroaromatic compound.

Clause 79. The method of any one of the preceding clauses, wherein the ceramic-polymer composite solid-state electrolyte comprises polybenzimidazole (PBI), polybenzobisoxazole (PBT) or polybenzobisthiazole (PBT).

Clause 80. The method of any one of the preceding clauses, wherein the ceramic-polymer composite solid-state electrolyte comprises a polyheterocyclic compound.

Clause 81. The method of any one of the preceding clauses, wherein the ceramic-polymer composite solid-state electrolyte comprises polypyrrole.

Clause 82. The method of any one of the preceding clauses, wherein the ceramic-polymer composite solid-state electrolyte comprises a polyurethane.

Clause 83. The method of any one of the preceding clauses, wherein the ceramic-polymer composite solid-state electrolyte comprises a phenolic polymer.

Clause 84. The method of any one of the preceding clauses, wherein the ceramic-polymer composite solid-state electrolyte comprises phenol-formaldehyde.

Clause 85. The method of any one of the preceding clauses, wherein the ceramic-polymer composite solid-state electrolyte comprises a polyalkyne.

Clause 86. The method of any one of the preceding clauses, wherein the ceramic-polymer composite solid-state electrolyte comprises polyacetylene.

Clause 87. The method of any one of the preceding clauses, wherein the ceramic-polymer composite solid-state electrolyte comprises a polydiene.

Clause 88. The method of any one of the preceding clauses, wherein the ceramic-polymer composite solid-state electrolyte comprises 1,2-polybutadiene, cis-1,4-polybutadiene or trans-1,4-polybutadiene.

Clause 89. The method of any one of the preceding clauses, wherein the ceramic-polymer composite solid-state electrolyte comprises a polysiloxane.

Clause 90. The method of any one of the preceding clauses, wherein the ceramic-polymer composite solid-state electrolyte comprises poly(dimethylsiloxane) (PDMS), poly(diethylsiloxane) (PDES), polydiphenylsiloxane (PDPS), or polymethylphenylsiloxane (PMPS).

Clause 91. The method of any one of the preceding clauses, wherein the ceramic-polymer composite solid-state electrolyte comprises an inorganic polymer.

Clause 92. The method of any one of the preceding clauses, wherein the ceramic-polymer composite solid-state electrolyte comprises polyphosphazene.

Clause 93. The method of any one of the preceding clauses, wherein the ceramic-polymer composite solid-state electrolyte comprises a polyphosphonate.

Clause 94. The method of any one of the preceding clauses, wherein the ceramic-polymer composite solid-state electrolyte comprises a polysilane.

Clause 95. The method of any one of the preceding clauses, wherein the ceramic-polymer composite solid-state electrolyte comprises a polysilazane.

Clause 96. The method of any one of the preceding clauses, wherein the ceramic-polymer composite solid-state electrolyte comprises an ionic conductive salt.

Clause 97. The method of any one of the preceding clauses, wherein the ceramic-polymer composite solid-state electrolyte comprises a lithium ionic conductive salt.

Clause 98. The method of any one of the preceding clauses, wherein the ceramic-polymer composite solid-state electrolyte comprises lithium bis(trifluoromethanesulfonyl)imide (LiTFSI), lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), or LiNO₃.

Clause 99. The method of any one of the preceding clauses, wherein the ceramic-polymer composite solid-state electrolyte comprises a sodium ionic conductive salt.

Clause 100. The method of any one of the preceding clauses, wherein the ceramic-polymer composite solid-state electrolyte comprises sodium bis(trifluoromethanesulfonyl)imide (NaTFSI), sodium bis(fluorosulfonyl)imide (NaFSI), sodium bis(oxalato)borate (NaBOB), Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, or NaNO₃,

Clause 101. The method of any one of the preceding clauses, wherein the ceramic-polymer composite solid-state electrolyte comprises a magnesium ionic conductive salt.

Clause 102. The method of any one of the preceding clauses, wherein the ceramic-polymer composite solid-state electrolyte comprises magnesium bis(trifluoromethanesulfonyl)imide (Mg(TFSI)₂), magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, or Mg(CH₃COOH)₂.

Clause 103. The method of any one of the preceding clauses, wherein the ceramic-polymer composite solid-state electrolyte comprises a potassium ionic conductive salt.

Clause 104. The method of any one of the preceding clauses, wherein the ceramic-polymer composite solid-state electrolyte comprises potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), or KNO₃.

Clause 105. The method of any one of the preceding clauses, wherein the ceramic-polymer composite solid-state electrolyte comprises an aluminum ionic conductive salt.

Clause 106. The method of any one of the preceding clauses, wherein the ceramic-polymer composite solid-state electrolyte comprises Al(NO₃)₂, AlCl₃, Al₂(SO₄)₃, AlBr₃, AlI₃, AlN, AlSCN, or Al(ClO₄)₃.

Clause 107. The method of any one of the preceding clauses, wherein the ceramic-polymer composite solid-state electrolyte comprises an ionic conductive ceramic.

Clause 108. The method of any one of the preceding clauses, wherein the ceramic-polymer composite solid-state electrolyte comprises an ionic conductive ceramic that is ionic conductive to H⁺, Li⁺, Na⁺, K⁺, Ag⁺, Mg²⁺, Al³⁺, Zn²⁺, and combinations thereof.

Clause 109. The method of any one of the preceding clauses, wherein the ceramic-polymer composite solid-state electrolyte comprises a garnet-like structure oxide material.

Clause 110. The method of any one of the preceding clauses, wherein the ceramic-polymer composite solid-state electrolyte comprises a garnet-like structure oxide material with the general formula:

Liₙ[A(_{3-a′-a″)}A′(_{a′})A″(_{a″})][B(_{2-b′-b″})B′(_{b′})B″(_{b″})][C′(_{c′})C″(_{c″})]O₁₂,

a. where A, A′, and A″ stand for an dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;

b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;

c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and

d. wherein n=7+a′+2·a″−b′−2·b″−3·c′−4·c″ and 4.5≤n≤7.5.

Clause 111. The method of any one of the preceding clauses, wherein the ceramic-polymer composite solid-state electrolyte comprises a perovskite-type oxide.

Clause 112. The method of any one of the preceding clauses, wherein the ceramic-polymer composite solid-state electrolyte comprises (Li,La)TiO₃ or (Li,La)TiO₃ with doped or replaced compounds.

Clause 113. The method of any one of the preceding clauses, wherein the ceramic-polymer composite solid-state electrolyte comprises NASICON-structured lithium membrane.

Clause 114. The method of any one of the preceding clauses, wherein the ceramic-polymer composite solid-state electrolyte comprises LAGP (Li₁-xAlₓGe₂₋ₓ(PO₄)₃).

Clause 115. The method of any one of the preceding clauses, wherein the ceramic-polymer composite solid-state electrolyte comprises LAGP (Li₁-xAlₓGe₂₋ₓ(PO₄)₃) with other elements doped therein.

Clause 116. The method of any one of the preceding clauses, wherein the ceramic-polymer composite solid-state electrolyte comprises LATP (Li₁+xAlₓTi₂₋ₓ(PO₄)₃).

Clause 117. The method of any one of the preceding clauses, wherein the ceramic-polymer composite solid-state electrolyte comprises LATP (Li₁+xAlₓTi₂₋ₓ(PO₄)₃) with other elements doped therein.

Clause 118. The method of any one of the preceding clauses, wherein the ceramic-polymer composite solid-state electrolyte comprises an anti-perovskite structure material or derivative thereof.

Clause 119. The method of any one of the preceding clauses, wherein the ceramic-polymer composite solid-state electrolyte comprises a Li₃OCl, Li₃OBr, or Li₃OI.

Clause 120. The method of any one of the preceding clauses, wherein the ceramic-polymer composite solid-state electrolyte comprises a material from the Li₃YH₆(H═F, Cl, Br, I) family of materials, wherein Y can be replaced by other rare earth elements.

Clause 121. The method of any one of the preceding clauses, wherein the ceramic-polymer composite solid-state electrolyte comprises Li₂ₓS_{x+w+5z}M_{y}P_{2z}, wherein x is 8-16, y is 0.1-6, w is 0.1-15, z is 0.1-3, and wherein M is selected from the group consisting of lanthanides, Group 3, Group 4, Group 5, Group 6, Group 7, Group 8, Group 9, Group 12, Group 13, and Group 14 atoms, and combinations thereof.

Clause 122. The method of any one of the preceding clauses, wherein the ceramic-polymer composite solid-state electrolyte comprises an argyrodites material.

Clause 123. The method of any one of the preceding clauses, wherein the ceramic-polymer composite solid-state electrolyte comprises an argyrodites material with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻═O²⁻, S²⁻, Te²⁻, or a combination thereof; X⁻═F⁻, Cl⁻, Br⁻, I⁻, or a combination thereof, and x is in the range of 0≤x≤2.

Clause 124. The method of any one of the preceding clauses, wherein the ceramic-polymer composite solid-state electrolyte comprises an ionic conductive ceramic in a range of from greater than 0% to less than 100% by mass of the total mass of the ceramic-polymer composite solid-state electrolyte.

Clause 125. The method of any one of the preceding clauses, wherein the ceramic-polymer composite solid-state electrolyte comprises an ionic conductive ceramic in a range of from 80% to 99.99% by mass of the total mass of the ceramic-polymer composite solid-state electrolyte.

Clause 126. The method of any one of the preceding clauses, wherein the ceramic-polymer composite solid-state electrolyte comprises an ionic conductive ceramic in a range of from 90% to 99.9% by mass of the total mass of the ceramic-polymer composite solid-state electrolyte.

Clause 127. The method of any one of the preceding clauses, wherein the ceramic-polymer composite solid-state electrolyte comprises an ionic conductive ceramic in a range of from 95% to 99.5% by mass of the total mass of the ceramic-polymer composite solid-state electrolyte.

Clause 128. The method of any one of the preceding clauses, wherein the ceramic-polymer composite solid-state electrolyte comprises ionic conductive ceramic particles, wherein the ionic conductive ceramic particles have a particle size in the range of 0.001<d<100 μm.

Clause 129. The method of any one of the preceding clauses, wherein the ceramic-polymer composite solid-state electrolyte comprises ionic conductive ceramic particles, wherein the ionic conductive ceramic particles have a particle size in the range of 0.1<d<10 μm.

Clause 130. The method of any one of the preceding clauses, wherein the ceramic-polymer composite solid-state electrolyte comprises ionic conductive ceramic particles, wherein the ionic conductive ceramic particles have a morphology including one or more of nanoparticles, cubes, nanocubes, fibers, nanofibers, wires, nanowires, quantum dots, nanotubes, and octahedrons.

Clause 131. The method of any one of the preceding clauses, wherein the ceramic-polymer composite solid-state electrolyte includes a porosity of less than 20% by total volume of the ceramic-polymer composite solid-state electrolyte.

Clause 132. The method of any one of the preceding clauses, wherein the ceramic-polymer composite solid-state electrolyte includes a porosity of less than 18% by total volume of the ceramic-polymer composite solid-state electrolyte.

Clause 133. The method of any one of the preceding clauses, wherein the ceramic-polymer composite solid-state electrolyte includes a porosity of less than 16% by total volume of the ceramic-polymer composite solid-state electrolyte.

Clause 134. The method of any one of the preceding clauses, wherein the ceramic-polymer composite solid-state electrolyte includes a porosity of less than 14% by total volume of the ceramic-polymer composite solid-state electrolyte.

Clause 135. The method of any one of the preceding clauses, wherein the ceramic-polymer composite solid-state electrolyte includes a porosity of less than 12% by total volume of the ceramic-polymer composite solid-state electrolyte.

Clause 136. The method of any one of the preceding clauses, wherein the ceramic-polymer composite solid-state electrolyte includes a porosity of less than 10% by total volume of the ceramic-polymer composite solid-state electrolyte.

Clause 137. The method of any one of the preceding clauses, wherein the ceramic-polymer composite solid-state electrolyte includes a porosity of less than 8% by total volume of the ceramic-polymer composite solid-state electrolyte.

Clause 138. The method of any one of the preceding clauses, wherein the ceramic-polymer composite solid-state electrolyte includes a porosity of less than 6% by total volume of the ceramic-polymer composite solid-state electrolyte.

Clause 139. The method of any one of the preceding clauses, wherein the ceramic-polymer composite solid-state electrolyte includes an ionic conductive ceramic, wherein the ionic conductive ceramic is present in a range of from greater than 0% to less than 100% by volume of the total volume of the ceramic-polymer composite solid-state electrolyte.

Clause 140. The method of any one of the preceding clauses, wherein the ceramic-polymer composite solid-state electrolyte includes an ionic conductive ceramic, wherein the ionic conductive ceramic is present in a range of from 50% to 99.99% by volume of the total volume of the ceramic-polymer composite solid-state electrolyte.

Clause 141. The method of any one of the preceding clauses, wherein the ceramic-polymer composite solid-state electrolyte includes an ionic conductive ceramic, wherein the ionic conductive ceramic is present in a range of from 60% to 99.95% by volume of the total volume of the ceramic-polymer composite solid-state electrolyte.

Clause 142. The method of any one of the preceding clauses, wherein the ceramic-polymer composite solid-state electrolyte includes an ionic conductive ceramic, wherein the ionic conductive ceramic is present in a range of from 70% to 99.9% by volume of the total volume of the ceramic-polymer composite solid-state electrolyte.

Clause 143. The method of any one of the preceding clauses, wherein the ceramic-polymer composite solid-state electrolyte includes an ionic conductive ceramic, wherein the ionic conductive ceramic is present in a range of from 80% to 99.5% by volume of the total volume of the ceramic-polymer composite solid-state electrolyte.

Clause 144. The method of any one of the preceding clauses, wherein the ceramic-polymer composite solid-state electrolyte includes an ionic conductive ceramic, wherein the ionic conductive ceramic is present in a range of from 85% to 99% by volume of the total volume of the ceramic-polymer composite solid-state electrolyte.

Clause 145. The method of any one of the preceding clauses having a thickness in a range of 1<t<1000 μm.

Clause 146. The method of any one of the preceding clauses having a thickness in a range of 10<t<100 μm.

Clause 147. The method of any one of the preceding clauses, wherein a ratio of a thickness of the solid-state electrolyte membrane to a thickness of the fabric support is in a range of from greater than 1 to 5.

Clause 148. The method of any one of the preceding clauses, wherein a ratio of a thickness of the solid-state electrolyte membrane to a thickness of the fabric support is in a range of from greater than 1 to 2.

Clause 149. The method of any one of the preceding clauses, wherein a ratio of a thickness of the solid-state electrolyte membrane to a thickness of the fabric support is in a range of from greater than 1 to 1.5.

Clause 150. The method of any one of the preceding clauses, wherein a ratio of a thickness of the solid-state electrolyte membrane to a thickness of the fabric support is in a range of from greater than 1 to 1.2.

Clause 151. The method of any one of the preceding clauses, wherein the ceramic-polymer composite solid-state electrolyte further comprises a nonionic conducting additive.

Clause 152. The method of any one of the preceding clauses, wherein the ceramic-polymer composite solid-state electrolyte further comprises alumina, titanium, lanthanum oxide, or zirconia.

Clause 153. The method of any one of the preceding clauses, wherein the ceramic-polymer composite solid-state electrolyte further comprises an epoxy.

Clause 154. The method of any one of the preceding clauses, wherein the ceramic-polymer composite solid-state electrolyte further comprises a resin.

Clause 155. The method of any one of the preceding clauses, wherein the ceramic-polymer composite solid-state electrolyte further comprises a plasticizer.

Clause 156. The method of any one of the preceding clauses, wherein the ceramic-polymer composite solid-state electrolyte further comprises a surfactant.

Clause 157. The method of any one of the preceding clauses, wherein the ceramic-polymer composite solid-state electrolyte further comprises a binder.

Clause 158. The method of any one of the preceding clauses, wherein the ceramic-polymer composite solid-state electrolyte further comprises an ionic conducting additive.

Clause 159. The method of any one of the preceding clauses, wherein the ceramic-polymer composite solid-state electrolyte further comprises ethylene carbonate (EC), dimethyl carbonate (DMC), and diethyl carbonate (DEC), propylene carbonate (PC), tetraethylene glycol dimethyl ether (TEGDME), fluoroethylene carbonate (FEC), vinylene carbonate (VC), or vinyl ethylene carbonate (VEC).

1. A solid-state electrolyte membrane, comprising: a fabric support; and a ceramic-polymer composite solid-state electrolyte on the fabric support.

2. The solid-state electrolyte membrane of claim 1, wherein the fabric support is electrically insulative.

3. The solid-state electrolyte membrane of claim 1, wherein the fabric support is electrically conductive with an electrically insulative coating.

4. The solid-state electrolyte membrane of claim 1, wherein the ceramic-polymer composite solid-state electrolyte comprises an ionic conductive polymer.

5. The solid-state electrolyte membrane of claim 1, wherein the ceramic-polymer composite solid-state electrolyte comprises an nonionic conductive polymer.

6. The solid-state electrolyte membrane of claim 1, wherein the ceramic-polymer composite solid-state electrolyte comprises an ionic conductive salt.

7. The solid-state electrolyte membrane of claim 1, wherein the ceramic-polymer composite solid-state electrolyte comprises an ionic conductive ceramic.

8. The solid-state electrolyte membrane of claim 1, wherein the ceramic-polymer composite solid-state electrolyte comprises an ionic conductive ceramic in a range of from 0.01% to 99.99% by mass of the total mass of the ceramic-polymer composite solid-state electrolyte.

9. The solid-state electrolyte membrane of claim 1, wherein the ceramic-polymer composite solid-state electrolyte comprises ionic conductive ceramic particles, wherein the ionic conductive ceramic particles have a particle size in the range of 0.001<d<100 μm.

10. The solid-state electrolyte membrane of claim 1, wherein the ceramic-polymer composite solid-state electrolyte includes a porosity of less than 20% by total volume of the ceramic-polymer composite solid-state electrolyte.

11. The solid-state electrolyte membrane of claim 1, wherein the ceramic-polymer composite solid-state electrolyte includes an ionic conductive ceramic, wherein the ionic conductive ceramic is present in a range of from 0.01% to 99.99% by volume of the total volume of the ceramic-polymer composite solid-state electrolyte.

12. The solid-state electrolyte membrane of claim 1, wherein the ceramic-polymer composite solid-state electrolyte includes a polymer that reacts with the ionic conductive ceramic to increase the ionic conductivity of the solid-state electrolyte membrane.

13. The solid-state electrolyte membrane of claim 1, wherein a ratio of a thickness of the solid-state electrolyte membrane to a thickness of the fabric support is in a range of from greater than 1 to 2.

14. A secondary battery, comprising: a cathode, an anode, and the solid-state electrolyte membrane of any one of the preceding clauses between the cathode and the anode, the solid-state electrolyte membrane comprising a fabric support and a ceramic-polymer composite solid-state electrolyte on the fabric support.

15. The secondary battery of claim 14, wherein the cathode comprises a composite cathode.

16. The secondary battery of claim 14, wherein the anode comprises a metal or metal-alloy anode.

17. The secondary battery of claim 14, wherein the anode comprises a composite anode.

18. The secondary battery of claim 14, further comprising a liquid-based electrolyte.

19. The secondary battery of claim 14 excluding any liquid-based electrolyte.

20. A method for manufacturing a solid-state electrolyte membrane, the method comprising coating a ceramic-polymer composite solid-state electrolyte on a fabric support.

21. (canceled)

22. (canceled)
